(19) United States
(12) Patent Application Publication
(10) Pub. No.: US 2026/0045418 A1
(43) Pub. Date: Feb. 12, 2026

(54) MULTILAYER CERAMIC CAPACITOR

(71) Applicant: Murata Manufacturing Co., Ltd., Nagaokakyo-shi (JP)

(72) Inventor: Jun KURITANI, Nagaokakyo-shi (JP)

(21) Appl. No.: 19/081,307

(22) Filed: Mar. 17, 2025

(30) Foreign Application Priority Data
Aug. 9, 2024 (JP) 2024-134307

(51) Int. Cl. H01G 4/252; H01G 4/30

(52) U.S. Cl. CPC H01G 4/252; H01G 4/30

(57) ABSTRACT

A multilayer ceramic capacitor includes first and second surfaces facing each other, third and fourth surfaces facing each other, and fifth and sixth surface facing each other, a first outer electrode on the first and third surfaces, a second outer electrode on the first and fourth surfaces, a third outer electrode on the first and third surfaces, and a fourth outer electrode on the first and fourth surfaces. The first outer electrode includes a first underlying plating layer, a first thin-film layer and a first surface plating layer. The first underlying plating layer includes a first outer plating region on the third surface and coupled to a first inner electrode, and a first inner plating region extended toward the first surface and coupled to the first inner electrode. The first inner plating region is located inside the third to sixth surfaces.

### CROSS REFERENCE TO RELATED APPLICATIONS

This application claims the benefit of priority to Japanese Patent Application No. 2024-134307 filed on Aug. 9, 2024. The entire contents of this application are hereby incorporated herein by reference.

### BACKGROUND OF THE INVENTION

### 1. Field of the Invention

The present invention relates to multilayer ceramic capacitors.

### 2. Description of the Related Art

Electronic devices, such as mobile phones and portable music players, have been becoming smaller and thinner in recent years. The multilayer ceramic capacitors mounted within such smaller and thinner electronic devices have been becoming smaller and thinner accordingly (see, for example, Japanese Unexamined Patent Application Publication No. 2021-101449). For example, multilayer ceramic capacitors that have been particularly becoming thinner are embedded within wiring boards for use or mounted in very narrow gaps even when mounted on the surface of wiring boards.

As a multilayer ceramic capacitor designed to be thinner, a multilayer ceramic capacitor described in Japanese Unexamined Patent Application Publication No. 2021-101449 is disclosed. In a method for forming multilayer ceramic capacitors described in Japanese Unexamined Patent Application Publication No. 2021-101449 and the like, the underlying layer is formed as a sputtered film by a sputtering process with areas other than outer electrodes masked. However, when the underlying layer, such as a sputtered film, is insufficiently bonded to the multilayer body, the underlying layer may peel off from the multilayer body, leading to a risk of moisture entering.

### SUMMARY OF THE INVENTION

Accordingly, example embodiments of the present invention provide multilayer ceramic capacitors each with improved humidity resistance and peeling-off of the underlying layer from the multilayer body is reduced or prevented.

A multilayer ceramic capacitor according to an example embodiment of the present invention includes a multilayer body including a first surface and a second surface that face each other in a lamination direction, a third surface and a fourth surface that face each other in a first direction perpendicular or substantially perpendicular to the lamination direction, and a fifth surface and a sixth surface that face each other in a second direction perpendicular or substantially perpendicular to the lamination direction and the first direction, a first outer electrode on the first surface and the third surface, a second outer electrode on the first surface and the fourth surface, a third outer electrode on the first surface and the third surface, and a fourth outer electrode on the first surface and the fourth surface. The first outer electrode includes a first underlying plating layer, a first thin-film layer, and a first surface plating layer. The first underlying plating layer includes a first outer plating region on the third surface and coupled to a first inner electrode, and a first inner plating region extending toward the first surface and coupled to the first inner electrode. The first inner plating region is located inside the third to sixth surfaces, and the first thin-film layer covers the first inner plating region.

With a multilayer ceramic capacitor according to an example embodiment of the present invention, the first outer electrode includes the first underlying plating layer, the first thin-film layer, and the first surface plating layer, and the first underlying plating layer includes the first outer plating region on the third surface and coupled to the first inner electrode, and the first inner plating region extending toward the first surface and coupled to the first inner electrode. The first inner plating region is located inside the third to sixth surfaces, and the first thin-film layer covers the first inner plating region. The multilayer body includes an uneven surface due to the inner plating region. An anchor effect to the uneven surface improves the adhesion between the thin-film layer and the multilayer body, thus improving the humidity resistance of the multilayer ceramic capacitor.

According to example embodiments of the present invention, multilayer ceramic capacitors are provided each with improved humidity resistance and peeling-off of the underlying layer from the multilayer body is reduced or prevented.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view of an exemplary multilayer ceramic capacitor according to a first example embodiment of the present invention.

FIG. 2 is a front view of the exemplary multilayer ceramic capacitor according to the first example embodiment of the present invention.

FIG. 3 is a side view of the exemplary multilayer ceramic capacitor according to the first example embodiment of the present invention.

FIG. 4 is a schematic sectional view along a line IV-IV in FIG. 1.

FIG. 5 is a schematic sectional view along a line V-V in FIG. 1.

FIG. 6 is a schematic sectional view along a line VI-VI in FIG. 1.

FIG. 7 is a schematic sectional view along a line VII-VII in FIG. 1.

FIG. 8 is a schematic sectional view of another example of inner plating regions according to an example embodiment of the present invention.

FIG. 9A is a schematic sectional view along a line IXA-IXA in FIG. 2.

FIG. 9B is a schematic sectional view along a line IXB-IXB in FIG. 2.

FIG. 10 is an exploded perspective view of a multilayer body illustrated in FIG. 1.

FIG. 11 is an external perspective view illustrating a state where underlying plating layers are disposed on the multilayer body.

FIG. 12 is an external perspective view illustrating a state where the underlying plating layers and thin-film layers are disposed on the multilayer body.

FIG. 13 is an external perspective view of an exemplary multilayer ceramic capacitor according to a second example embodiment of the present invention, as seen from one side.

FIG. 14 is an external perspective view of the exemplary multilayer ceramic capacitor according to the second example embodiment of the present invention, as seen from the other side.

FIG. 15 is a front view of the exemplary multilayer ceramic capacitor according to the second example embodiment of the present invention.

FIG. 16 is a schematic sectional view along a line XVI-XVI in FIG. 13.

FIG. 17 is a schematic sectional view along a line XVII-XVII in FIG. 13.

FIG. 18 is a schematic sectional view along a line XVIII-XVIII in FIG. 13.

FIG. 19 is a schematic sectional view along a line XIX-XIX in FIG. 13.

FIG. 20A is a schematic sectional view along a line XXA-XXA in FIG. 15.

FIG. 20B is a schematic sectional view along a line XXB-XXB in FIG. 15.

FIG. 21 is an exploded perspective view of the multilayer body illustrated in FIG. 16.

FIG. 22 is an external perspective view of an exemplary multilayer ceramic capacitor according to a third example embodiment of the present invention.

FIG. 23 is a front view of the exemplary multilayer ceramic capacitor according to the third example embodiment of the present invention.

FIG. 24 is a schematic sectional view along a line XXIV-XXIV in FIG. 22.

FIG. 25 is a schematic sectional view along a line XXV-XXV in FIG. 22.

FIG. 26 is a schematic sectional view along a line XXVI-XXVI in FIG. 22.

FIG. 27 is a schematic sectional view along a line XXVII-XXVII in FIG. 22.

### DETAILED DESCRIPTION OF THE EXAMPLE EMBODIMENTS

Example embodiments of the present invention will be described in detail below with reference to the drawings.

### A. First Example Embodiment

### 1. Multilayer Ceramic Capacitor

Next, an example of a multilayer ceramic capacitor 10 according to an example embodiment of the present invention will be described.

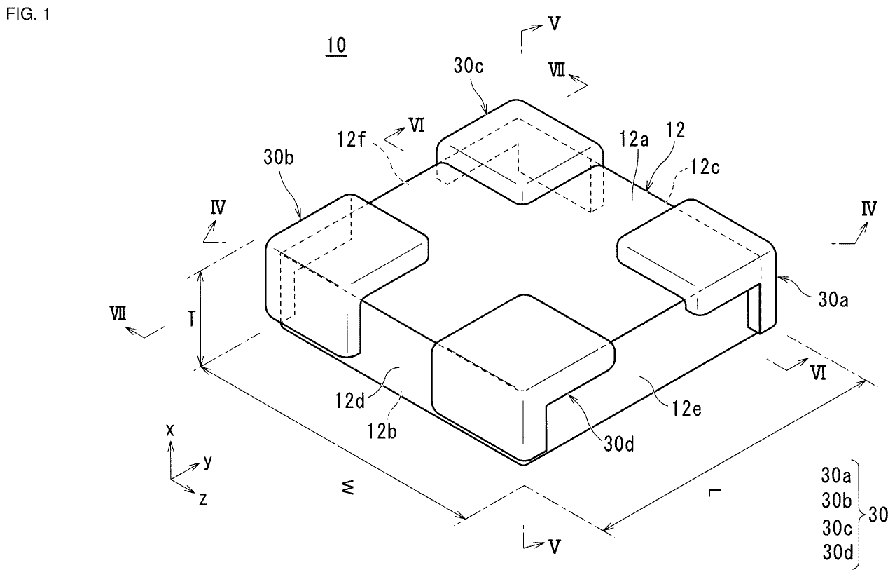

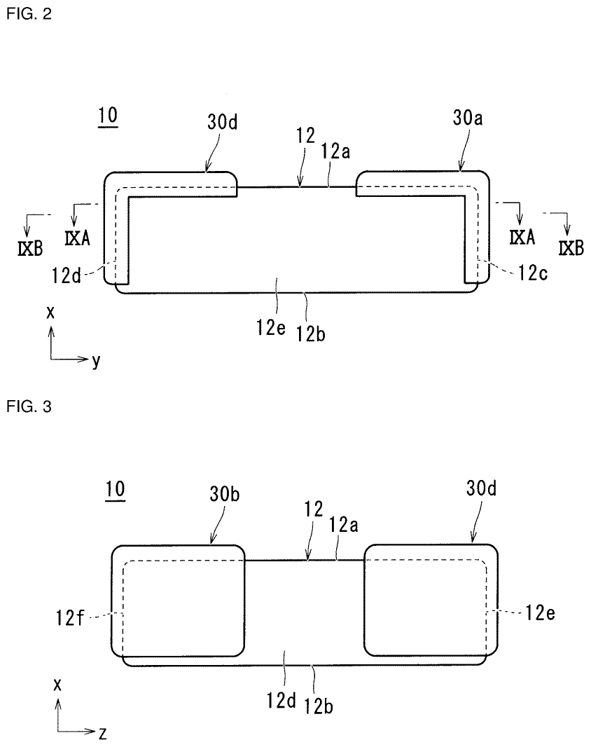

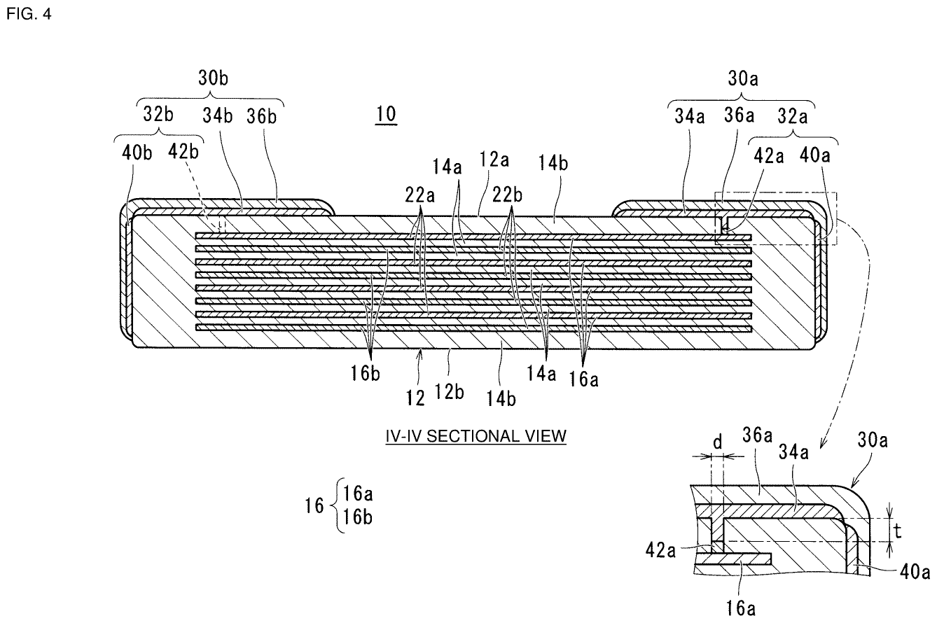

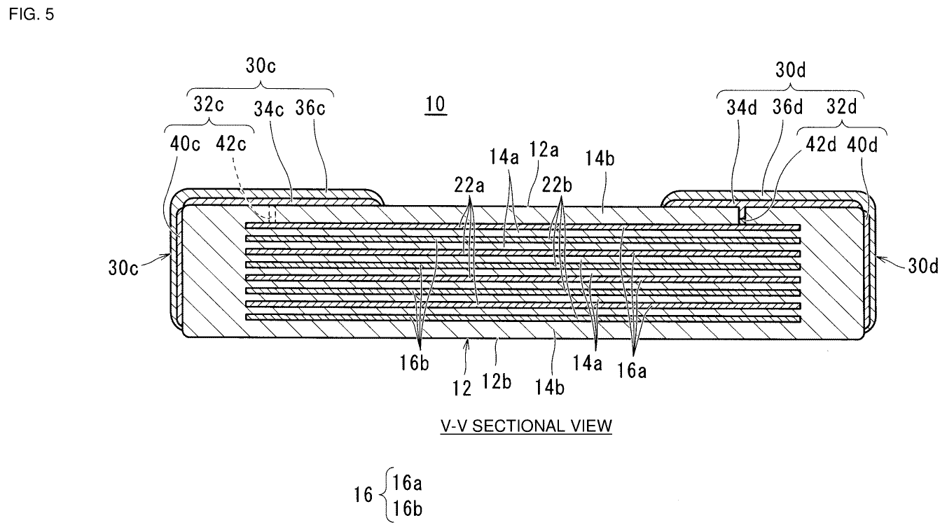

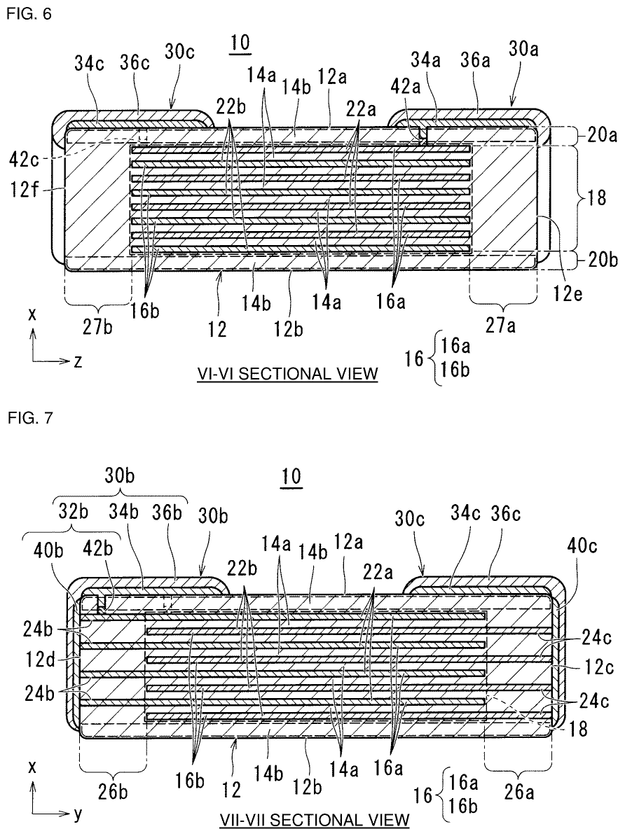

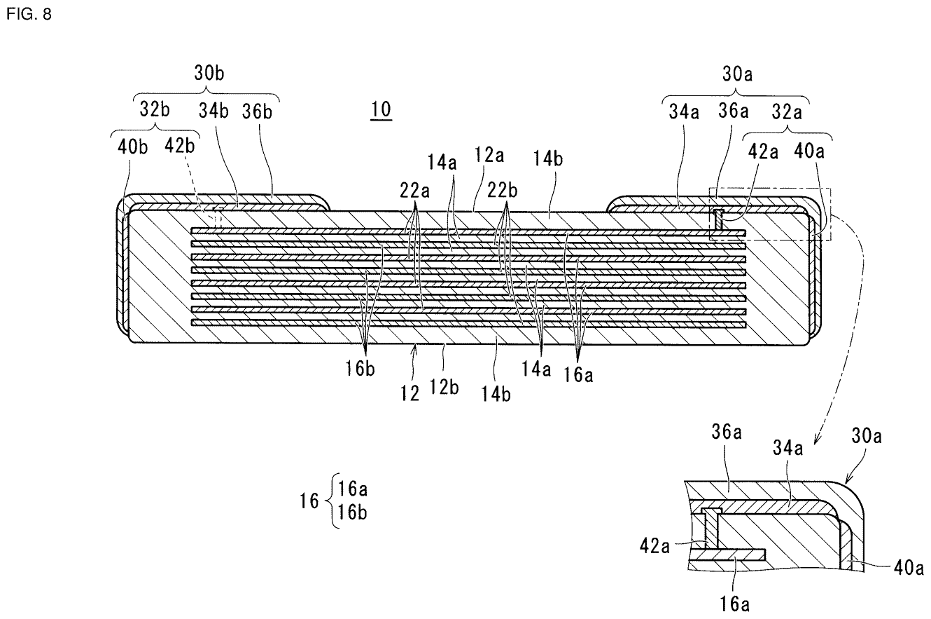

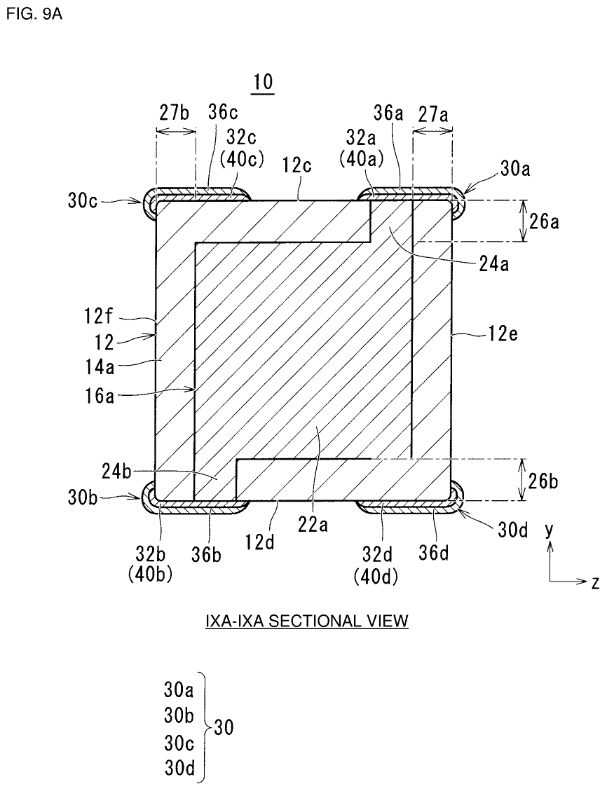

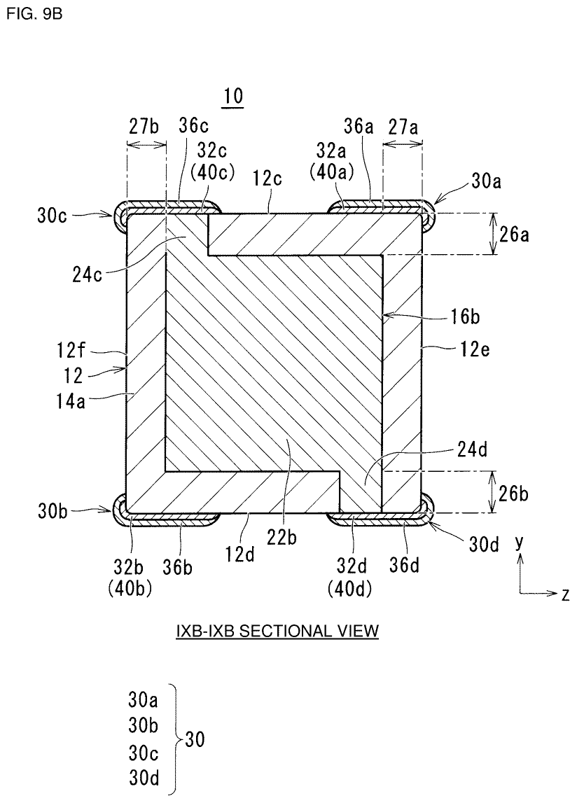

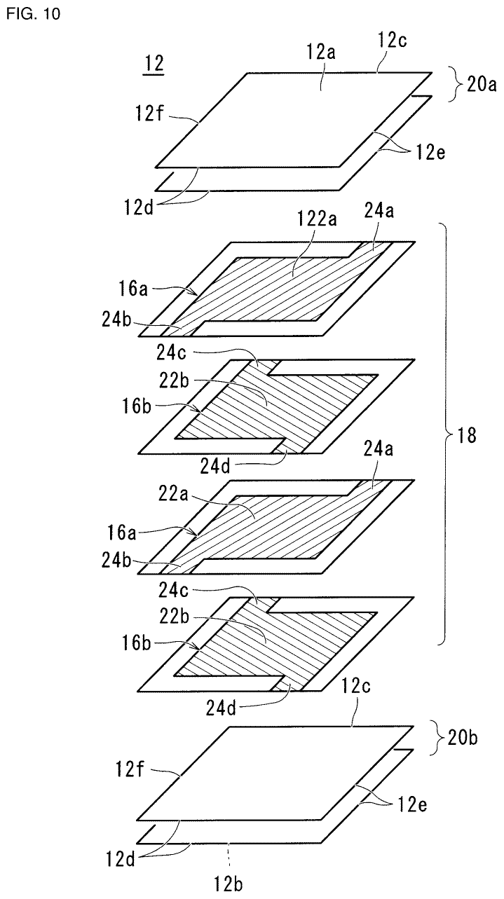

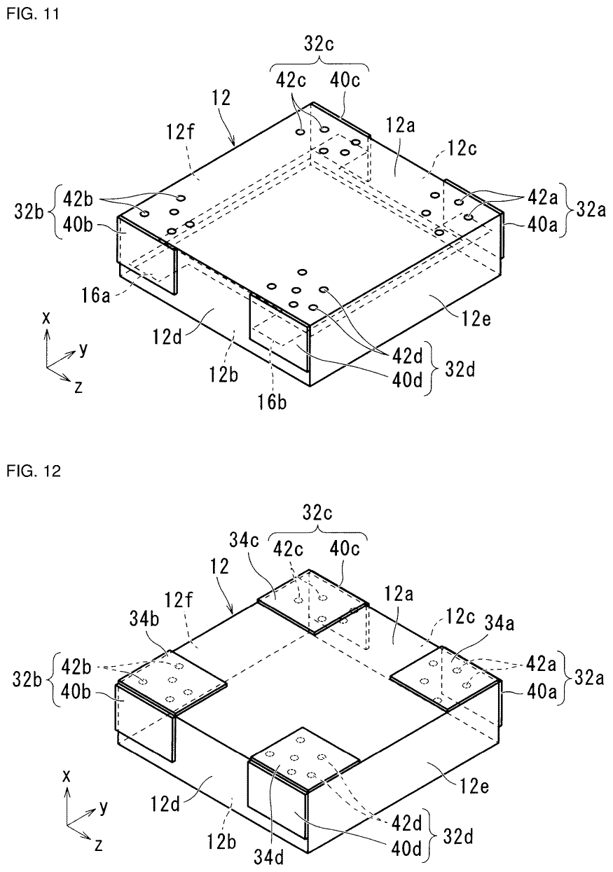

FIG. 1 is an external perspective view of an exemplary multilayer ceramic capacitor according to a first example embodiment of the present invention. FIG. 2 is a front view of the exemplary multilayer ceramic capacitor according to the first example embodiment of the present invention. FIG. 3 is a side view of the exemplary multilayer ceramic capacitor according to the first example embodiment of the present invention. FIG. 4 is a schematic sectional view along a line IV-IV in FIG. 1. FIG. 5 is a schematic sectional view along a line V-V in FIG. 1. FIG. 6 is a schematic sectional view along a line VI-VI in FIG. 1. FIG. 7 is a schematic sectional view along a line VII-VII in FIG. 1. FIG. 8 is a schematic sectional view of another example of inner plating regions of the present invention. FIG. 9A is a schematic sectional view along a line IXA-IXA in FIG. 2. FIG. 9B is a schematic sectional view along a line IXB-IXB in FIG. 2. FIG. 10 is an exploded perspective view of a multilayer body illustrated in FIG. 1. FIG. 11 is an external perspective view illustrating a state where underlying plating layers are disposed on the multilayer body. FIG. 12 is an external perspective view illustrating a state where the underlying plating layers and thin-film layers are disposed on the multilayer body.

The multilayer ceramic capacitor 10 includes a multilayer body 12 and plural outer electrodes 30.

### Multilayer Body

The multilayer body 12 includes a first surface 12a and a second surface 12b, which face each other in a lamination direction x, a third surface 12c and a fourth surface 12d, which face each other in a first direction y perpendicular or substantially perpendicular to the lamination direction x, and a fifth surface 12e and a sixth surface 12f, which face each other in a second direction Z perpendicular or substantially perpendicular to the lamination direction x and the first direction y. The lamination direction x is a direction connecting the first and second surfaces 12a and 12b of the multilayer body 12.

The multilayer body 12 preferably includes rounded corners and edge portions. Each corner portion refers to a portion at which three adjacent faces of the multilayer body 12 intersect. Each edge portion refers to a portion at which two adjacent faces of the multilayer body 12 intersect. A portion or all of the third and fourth surfaces 12c and 12d, as well as the fifth and sixth surfaces 12e and 12f, may include uneven surfaces, including protrusions and depressions.

Either the first surface 12a or the second surface 12b may include a roughened surface.

The multilayer body 12 includes plural dielectric layers 14 and plural inner electrodes 16. The dielectric layers 14 include inner dielectric layers 14a and outer dielectric layers 14b. The inner electrodes 16 include first inner electrodes 16a and second inner electrodes 16b.

The multilayer body 12 includes an inner-layer portion 18, a first outer-layer portion 20a, which is located on the first surface 12a side, and a second outer-layer portion 20b, which is located on the second surface 12b side.

The first outer-layer portion 20a is located on the first surface 12a side of the multilayer body 12 and is an assembly including the plural outer dielectric layers 14b located between the first surface 12a and the inner electrode 16 closest to the first surface 12a.

The second outer-layer portion 20b is located on the second surface 12b side of the multilayer body 12 and is an assembly including the plural outer dielectric layers 14b located between the second surface 12b and the inner electrode 16 closest to the second surface 12b.

The region sandwiched between the first outer-layer portion 20a and the second outer-layer portion 20b is referred to as the inner-layer portion 18.

The thickness of the first outer-layer portion 20a in the lamination direction x is, for example, greater than or equal to about 1.0 μm and less than or equal to about 4.0 μm. The thickness of the second outer-layer portion 20b in the lamination direction x is, for example, greater than or equal to about 1.0 μm and less than or equal to about 4.0 μm.

The inner-layer portion 18 includes the first inner electrodes 16a, the second inner electrodes 16b, and the inner dielectric layers 14a. One end of each first inner electrode 16a is exposed in the third surface 12c while the other end thereof is exposed in the fourth surface 12d. One end of each second inner electrode 16b is exposed in the third surface 12c while the other end thereof is exposed in the fourth surface 12d.

The dielectric layers 14 can be made of a dielectric material, for example. The dielectric material can be a dielectric ceramic mainly composed of BaTiO₃, CaTiO₃, SrTiO₃, CaZro₃, or the like, for example. The dielectric material may include a material obtained by adding a sub-component, such as a Mn compound, a Fe compound, a Cr compound, a Co compound, or a Ni compound to the main components. The inner dielectric layers 14a and the outer dielectric layers 14b are preferably made of the same dielectric material. The inner dielectric layers 14a and the outer dielectric layers 14b may be made of different dielectric materials in order to separate the functions of the inner-layer portion 18 and the outer-layer portions 20a and 20b. Furthermore, at least one of, for example, Si, Mg, Ba, Mn, Sn, or the like may be added to the dielectric material as an additive.

The inner dielectric layers 14a including a high amount of, for example, CaTiO₃ or CaZro₃ as the dielectric component can prevent insulation breakdown from occurring between the first and second inner electrodes 16a and 16b. The inner dielectric layers 14a, not limited thereto, can also be mainly include, for example, SrTiO₃ or the like. Alternatively, in order to increase the capacitance of the multilayer ceramic capacitor 10, the inner dielectric layers 14a are preferably made of a material having a high dielectric constant, for example, such as BaTiO₃.

The dielectric layers 14 can include, for example, plural crystal grains including a perovskite compound based on BaTiO₃ as the fundamental structure.

As the thickness of the dielectric layers 14 decreases, the capacitor's capacitance increases. Therefore, the size of the crystal grains is, for example, preferably smaller than or equal to about 1 μm.

The number of dielectric layers 14 laminated is not limited but is, for example, preferably greater than or equal to 3 and less than or equal to 300, including the first and second outer-layer portions 20a and 20b. The thickness of the dielectric layers 14 is preferably greater than or equal to about 0.4 μm and less than or equal to about 2.0 μm, for example.

Dimension L of the multilayer body 12 in the first direction y and dimension W in the second direction z satisfy the condition: about 0.85≤L/W≤about 1.00, for example. Herein, the first direction y is the direction in which the third surface 12c and the fourth surface 12d face each other. The second direction z is the direction in which the fifth surface 12e and the sixth surface 12f face each other. That is, the multilayer body 12 has a tetragonal or substantially tetragonal shape.

### Inner Electrode

The inner electrodes 16 include plural first inner electrodes 16a and plural second inner electrodes 16b. The first and second inner electrodes 16a and 16b are alternately laminated with the dielectric layers 14 interposed therebetween.

The first inner electrodes 16a are disposed on the surfaces of the inner dielectric layers 14a. Each first inner electrode 16a faces the first and second surfaces 12a and 12b and includes a first opposing electrode portion 22a, which faces the corresponding second inner electrode 16b. The first inner electrodes 16a are laminated in the direction connecting the first and second surfaces 12a and 12b.

The first inner electrodes 16a are extended through first extended electrode portions 24a to the third surface 12c of the multilayer body 12 and are extended through second extended electrode portions 24b to the fourth surface 12d of the multilayer body 12. The first extended electrode portions 24a are extended on the fifth surface 12e side of the multilayer body 12, and the second extended electrode portions 24b are extended on the sixth surface 12f side of the multilayer body 12.

The second inner electrodes 16b are disposed on the surfaces of the inner dielectric layers 14a different from the inner dielectric layers 14a on which the first inner electrodes 16a are disposed. Each second inner electrode 16b faces the first and second surfaces 12a and 12b and includes a second opposing electrode portion 22b, which faces the corresponding first inner electrodes 16a. The second inner electrodes 16b are laminated in the direction connecting the first and second surfaces 12a and 12b.

The second inner electrodes 16b are extended through third extended electrode portions 24c to the third surface 12c of the multilayer body 12 and are extended through fourth extended electrode portions 24d to the fourth surface 12d of the multilayer body 12. The third extended electrode portions 24c are extended on the sixth surface 12f side of the multilayer body 12, and the fourth extended electrode portions 24d are extended on the fifth surface 12e side of the multilayer body 12.

The first inner electrodes 16a and the second inner electrodes 16b are not exposed in the fifth and sixth surfaces 12e and 12f of the multilayer body 12.

When the multilayer ceramic capacitor 10 is viewed in the lamination direction x, preferably, a straight line connecting the first and second extended electrode portions 24a and 24b of the first inner electrodes 16a intersects with a straight line connecting the third and fourth extended electrode portions 24c and 24d of the second inner electrodes 16b.

As illustrated in FIG. 7, the multilayer body 12 includes a side portion (W gap) 26a of the multilayer body 12, which is located between one end in the first direction y, of the second opposing electrode portion 22b of each second inner electrode 16b and the third surface 12c, and a side portion (W gap) 26b of the multilayer body 12, which is located between the other end in the first direction y, of the first opposing electrode portion 22a of each first inner electrode 16a and the fourth surface 12d.

As illustrated in FIG. 6, furthermore, the multilayer body 12 includes an end portion (L gap) 27a of the multilayer body 12, which is located between one end in the second direction z, of the second opposing electrode portion 22b of each second inner electrode 16b and the fifth surface 12e, and a side portion (L gap) 27b of the multilayer body 12, which is located between the other end in the second direction z, of the first opposing electrode portion 22a of each first inner electrode 16a and the sixth surface 12f.

The first inner electrodes 16a and the second inner electrodes 16b can be made of a suitable conducting material, for example, a metal such as Ni, Cu, Ag, Pd, or Au, or an alloy including at least one of these metals, such as Ni—Cu alloy or Ag—Pd alloy, but not limited thereto. The first inner electrodes 16a and the second inner electrodes 16b may be made of the same conducting material or may be made of different conducting materials.

Including Sn in the first and second inner electrodes 16a and 16b can reduce the electric field concentration on the interface between the inner electrodes 16 and the dielectric layers 14, thus improving high-temperature load reliability. Sn is able to exert sufficient effects even if Sn is included only in the first inner electrodes 16a or only in the second inner electrodes 16b.

The total number of the first and second inner electrodes 16a and 16b is, for example, preferably greater than or equal to 3 and less than or equal to 300. The thickness of the first and second inner electrodes 16a and 16b is not limited but is preferably greater than or equal to about 0.2 μm and less than or equal to about 2.0 μm, for example.

The multilayer body 12 of the multilayer ceramic capacitor 10 may include the structures described below.

In the multilayer ceramic capacitor 10, the third to sixth surfaces 12c to 12f of the multilayer body 12 may be bent so as to be concave toward the center of the multilayer body 12 when viewed in the lamination direction x. That is, the third to sixth surfaces 12c to 12f of the multilayer body 12 may be warped. In such a shape, the center of the bend or warpage is preferably near the center of the third to sixth surfaces 12c to 12f. This can increase the distance between the adjacent outer electrodes 30 (described later) and thus reduce the risk of conduction between the outer electrodes 30.

The regions in the third to sixth surfaces 12c to 12f to which the inner electrodes 16 are extended preferably have a curvature from the first surface 12a to the second surface 12b when viewed in at least one of the first and second directions y and z. This can increase the exposed area of the inner electrodes 16, thus increasing the area of contact between the inner electrodes 16 and the outer electrodes 30.

### Outer Electrode

In the multilayer ceramic capacitor 10 according to the first example embodiment, the outer electrodes 30 cover the first surface 12a of the multilayer body 12 and do not cover the second surface 12b.

The outer electrodes 30 are disposed on the multilayer body 12 as illustrated in FIGS. 1 to 7.

The outer electrodes 30 include plural outer electrodes 30, which are coupled to the first inner electrodes 16a and the second inner electrodes 16b. The outer electrodes 30 include a first outer electrode 30a, a second outer electrode 30b, a third outer electrode 30c, and a fourth outer electrode 30d.

The first outer electrode 30a is disposed on the third surface 12c so as to cover the first extended electrode portions 24a of the first inner electrodes 16a. The first outer electrode 30a is further disposed so as to cover a portion of the first surface 12a. The first outer electrode 30a is electrically coupled to the first extended electrode portions 24a of the first inner electrodes 16a.

The second outer electrode 30b is disposed on the fourth surface 12d so as to cover the second extended electrode portions 24b of the first inner electrodes 16a. The second outer electrode 30b is further disposed so as to cover a portion of the first surface 12a. The second outer electrode 30b is electrically coupled to the second extended electrode portions 24b of the first inner electrodes 16a.

The third outer electrode 30c is disposed on the third surface 12c so as to cover the third extended electrode portions 24c of the second inner electrodes 16b. The third outer electrode 30c is further disposed so as to cover a portion of the first surface 12a. The third outer electrode 30c is electrically coupled to the third extended electrode portions 24c of the second inner electrodes 16b.

The fourth outer electrode 30d is disposed on the fourth surface 12d so as to cover the fourth extended electrode portions 24d of the second inner electrodes 16b. The fourth outer electrode 30d is further disposed so as to cover a portion of the first surface 12a. The fourth outer electrode 30d is electrically coupled to the fourth extended electrode portions 24d of the second inner electrodes 16b.

Furthermore, as illustrated in FIG. 1, a portion of the outer electrodes 30 disposed on the fifth surface 12e or the sixth surface 12f, to which no inner electrode 16 is extended, preferably covers any one of the short sides of the side surface to which no inner electrode 16 is extended and the portion from an end of the short side to the middle of the long side.

Within the multilayer body 12, the first opposing electrode portions 22a of the first inner electrodes 16a and the second opposing electrode portions 22b of the second inner electrodes 16b face each other with the inner dielectric layers 14a interposed therebetween to generate capacitance. This can provide capacitance between the first and second outer electrodes 30a and 30b, to which the first inner electrodes 16a are coupled, and between the third and fourth outer electrodes 30c and 30d, to which the second inner electrodes 16b are coupled. The capacitor characteristics are thus provided.

The first outer electrode 30a, the second outer electrode 30b, the third outer electrode 30c, and the fourth outer electrode 30d each include an underlying plating layer 32, a thin-film layer 34, and a surface plating layer 36.

Specifically, the first outer electrode 30a includes a first underlying plating layer 32a, a first thin-film layer 34a, and a first surface plating layer 36a. The second outer electrode 30b includes a second underlying plating layer 32b, a second thin-film layer 34b, and a second surface plating layer 36b. The third outer electrode 30c includes a third underlying plating layer 32c, a third thin-film layer 34c, and a third surface plating layer 36c. The fourth outer electrode 30d includes a fourth underlying plating layer 32d, a fourth thin-film layer 34d, and a fourth surface plating layer 36d.

### Underlying Plating Layer

The underlying plating layers 32 include outer plating regions 40, which are provided on the third surface 12c and the fourth surface 12d, and inner plating regions 42, which are provided inside the third to sixth surfaces 12c to 12f and are extended toward the first surface 12a. That is, the inner plating regions 42 are extended from the inner electrode 16 closest to the first surface 12a in the lamination direction x, toward the first surface 12a. Hereinafter, the specific configuration of the underlying plating layers 32 will be described.

A first underlying plating layer 32a includes a first outer plating region 40a and a first inner plating region 42a.

The first outer plating region 40a is provided on the surface of the third surface 12c of the multilayer body 12 so as to cover the first extended electrode portions 24a of the first inner electrodes 16a exposed in the third surface 12c of the multilayer body 12.

The first inner plating region 42a is provided in a region of the first surface 12a located at a corner portion formed by the third and fifth surfaces 12c and 12e and is extended from the inner electrode 16 closest to the first surface 12a in the lamination direction x, toward the first surface 12a.

As illustrated in FIG. 4, the distance between the first surface 12a and the inner electrode 16 closest to the first surface 12a is longer than the dimension of the first inner plating region 42a in the lamination direction x. The first inner plating region 42a is therefore arranged so as to be recessed from the first surface 12a.

When the distance between the first surface 12a and the inner electrode 16 closest to the first surface 12a is longer than the dimension of the first inner plating region 42a in the lamination direction x, a distance t between the first inner plating region 42a and the first surface 12a in the lamination direction x is, for example, preferably less than or equal to about 0.5 μm. An exposed width d of the first inner plating region 42a is, for example, preferably greater than or equal to about 0.02 μm and less than or equal to about 3.1 μm. This can improve the bonding strength between the first thin-film layer 34a and the multilayer body 12.

On the other hand, as illustrated in FIG. 8, the first inner plating region 42a may protrude from the first surface 12a. Therefore, a portion of the first inner plating region 42a covers a portion of the surface of the first surface 12a. In such a configuration, since the distance between the first surface 12a and the inner electrode 16 closest to the first surface 12a is shorter than the dimension of the first inner plating region 42a in the lamination direction x, the first inner plating region 42a protrudes from the first surface 12a. When the distance between the first surface 12a and the inner electrode 16 closest to the first surface 12a is shorter than the dimension of the first inner plating region 42a in the lamination direction x, therefore, the first inner plating region 42a protrudes in the first surface 12a and covers the first surface 12a. This can improve the humidity resistance.

As described above, the multilayer body 12 includes an uneven surface due to the first inner plating region 42a. An anchor effect to the uneven surface can further improve the adhesion between the first thin-film layer 34a and the multilayer body 12.

The surface roughness ratio of the first outer-layer portion 20a, which faces the first inner plating region 42a, is, for example, preferably greater than or equal to about 1.5. The surface roughness ratio indicates the ratio of the actual path length to the straight-line length.

A second underlying plating layer 32b includes a second outer plating region 40b and a second inner plating region 42b.

The second outer plating region 40b is arranged on the surface of the fourth surface 12d of the multilayer body 12 so as to cover the second extended electrode portions 24b of the first inner electrodes 16a exposed in the fourth surface 12d of the multilayer body 12.

The second inner plating region 42b is provided in a region of the first surface 12a located at a corner portion defined by the fourth and sixth surfaces 12d and 12f and is extended from the inner electrode 16 closest to the first surface 12a in the lamination direction x, toward the first surface 12a.

Similarly to the first inner plating region 42a, the second inner plating region 42b may protrude from the first surface 12a or recessed from the first surface 12a.

When the distance between the first surface 12a and the inner electrode 16 closest to the first surface 12a is shorter than the dimension of the second inner plating region 42b in the lamination direction x, the second inner plating region 42b protrudes from the first surface 12a. On the other hand, when the distance between the first surface 12a and the inner electrode 16 closest to the first surface 12a is longer than the dimension of the second inner plating region 42b in the lamination direction x, the second inner plating region 42b is arranged is recessed from the first surface 12a. When the multilayer body 12 includes an uneven surface due to the second inner plating region 42b, its anchor effect can further improve the adhesion between the second thin-film layer 34b and the multilayer body 12.

The other configurations of the second inner plating region 42b are the same or substantially the same as those of the first inner plating region 42a.

A third underlying plating layer 32c includes a third outer plating region 40c and a third inner plating region 42c.

The third outer plating region 40c is arranged on the surface of the third surface 12c of the multilayer body 12 so as to cover the third extended electrode portions 24c of the second inner electrodes 16b exposed in the third surface 12c of the multilayer body 12.

The third inner plating region 42c is provided in a region of the first surface 12a located at a corner portion defined by the third and sixth surfaces 12c and 12f and is extended from the inner electrode 16 closest to the first surface 12a in the lamination direction x, toward the first surface 12a.

Similarly to the first inner plating region 42a, the third inner plating region 42c may protrude from the first surface 12a or be recessed from the first surface 12a.

When the distance between the first surface 12a and the inner electrode 16 closest to the first surface 12a is shorter than the dimension of the third inner plating region 42c in the lamination direction x, the third inner plating region 42c protrudes from the first surface 12a. On the other hand, when the distance between the first surface 12a and the inner electrode 16 closest to the first surface 12a is longer than the dimension of the third inner plating region 42c in the lamination direction x, the third inner plating region 42c is recessed from the first surface 12a. When the multilayer body 12 includes an uneven surface due to the third inner plating region 42c, its anchor effect can further improve the adhesion between the third thin-film layer 34c and the multilayer body 12.

The other configurations of the third inner plating region 42c are the same or substantially the same as those of the first inner plating region 42a.

A fourth underlying plating layer 32d includes a fourth outer plating region 40d and a fourth inner plating region 42d.

The fourth outer plating region 40d is arranged on the surface of the fourth surface 12d of the multilayer body 12 so as to cover the fourth extended electrode portions 24d of the second inner electrodes 16b exposed in the fourth surface 12d of the multilayer body 12.

The fourth inner plating region 42d is provided in a region of the first surface 12a located at a corner portion defined by the fourth and fifth surfaces 12d and 12e and is extended from the inner electrode 16 closest to the first surface 12a in the lamination direction x, toward the first surface 12a.

Similarly to the first inner plating region 42a, the fourth inner plating region 42d may protrude from the first surface 12a or be recessed from the first surface 12a.

When the distance between the first surface 12a and the inner electrode 16 closest to the first surface 12a is shorter than the dimension of the fourth inner plating region 42d in the lamination direction x, the fourth inner plating region 42d protrudes from the first surface 12a. On the other hand, when the distance between the first surface 12a and the inner electrode 16 closest to the first surface 12a is longer than the dimension of the fourth inner plating region 42d in the lamination direction x, the fourth inner plating region 42d is recessed from the first surface 12a. When the multilayer body 12 includes an uneven surface due to the fourth inner plating region 42d, its anchor effect can further improve the adhesion between the fourth thin-film layer 34d and the multilayer body 12.

The other configurations of the fourth inner plating region 42d are the same or substantially the same as those of the first inner plating region 42a.

The outer plating regions 40 and the inner plating regions 42 are preferably made of the same type of metal component. The outer and inner plating regions 40 and 42, which define the underlying plating layers 32, are preferably made of, for example, Cu plating although it depends on the connectivity with the inner electrodes 16.

The upper end of the first underlying plating layer 32a of the first outer electrode 30a may overlap the underside of the first thin-film layer 34a on the edge portion defined by the first and third surfaces 12a and 12c of the multilayer body 12 and the edge portion defined by the first and fifth surfaces 12a and 12e of the multilayer body 12 or to be spaced apart from the first thin-film layer 34a. In such a configuration, the first outer plating region 40a may cover the edge portion defined by the third and fifth surfaces 12c and 12e.

The upper end of the second underlying plating layer 32b of the second outer electrode 30b may overlap the underside of the second thin-film layer 34b on the edge portion defined by the first and fourth surfaces 12a and 12d of the multilayer body 12 and the edge portion defined by the first and sixth surfaces 12a and 12f of the multilayer body 12 or to be spaced apart from the second thin-film layer 34b. In such a configuration, the second outer plating region 40b may cover the edge portion defined by the fourth and sixth surfaces 12d and 12f.

The upper end of the third underlying plating layer 32c of the third outer electrode 30c may overlap the underside of the third thin-film layer 34c on the edge portion defined by the first and third surfaces 12a and 12c of the multilayer body 12 and the edge portion defined by the first and sixth surfaces 12a and 12f of the multilayer body 12 or to be spaced apart from the third thin-film layer 34c. In such a configuration, the third outer plating region 40c may cover the edge portion defined by the third and sixth surfaces 12c and 12f.

The upper end of the fourth underlying plating layer 32d of the fourth outer electrode 30d may overlap the underside of the fourth thin-film layer 34d on the edge portion defined by the first and fourth surfaces 12a and 12d of the multilayer body 12 and the edge portion defined by the first and fifth surfaces 12a and 12e of the multilayer body 12 or to be spaced apart from the fourth thin-film layer 34d. In such a configuration, the fourth outer plating region 40d may cover the edge portion formed by the fourth and fifth surfaces 12d and 12e.

The underlying plating layers 32 include, for example, Cu as a main metal component. When the first inner electrodes 16a and the second inner electrodes 16b are made of, for example, Ni, the underlying plating layers 32 preferably include Cu plating, which has good adhesion with Ni.

The underlying plating layers 32 are formed by, for example, plating growth from the inner electrodes 16.

The thickness of each underlying plating layer 32 is, for example, preferably greater than or equal to about 0.5 μm and less than or equal to about 10.0 μm.

### Thin-Film Layer

The thin-film layers 34 cover the inner plating regions 42 of the underlying plating layers 32. The thin-film layers 34 include the first thin-film layer 34a, the second thin-film layer 34b, the third thin-film layer 34c, and the fourth thin-film layer 34d.

The first thin-film layer 34a covers a portion of the first surface 12a of the multilayer body 12 on the third surface 12c side and the fifth surface 12e side and the first inner plating region 42a of the first underlying plating layer 32a and does not cover the second surface 12b, the third surface 12c, and the fifth surface 12e of the multilayer body 12. The first thin-film layer 34a may be spaced apart from the first outer plating region 40a or may overlap the first outer plating region 40a. The first thin-film layer 34a may be shaped so as to include a recess in the surface of the first surface plating layer 36a.

The second thin-film layer 34b covers a portion of the first surface 12a of the multilayer body 12 on the fourth surface 12d side and the sixth surface 12f side and the second inner plating region 42b of the second underlying plating layer 32b and does not cover the second surface 12b, the fourth surface 12d, and the sixth surface 12f of the multilayer body 12. The second thin-film layer 34b may be spaced apart from the second outer plating region 40b or may overlap the second outer plating region 40b. The second thin-film layer 34b may be shaped so as to include a recess in the surface of the second surface plating layer 36b.

The third thin-film layer 34c covers a portion of the first surface 12a of the multilayer body 12 on the third surface 12c side and the sixth surface 12f side and the third inner plating region 42c of the third underlying plating layer 32c and does not cover the second surface 12b, the third surface 12c, and the sixth surface 12f of the multilayer body 12. The third thin-film layer 34c may be spaced apart from the third outer plating region 40c or may overlap the third outer plating region 40c. The third thin-film layer 34c may be shaped so as to include a recess in the surface of the third surface plating layer 36c.

The fourth thin-film layer 34d covers a portion of the first surface 12a of the multilayer body 12 on the fourth surface 12d side and the fifth surface 12e side and the fourth inner plating region 42d of the fourth underlying plating layer 32d and does not cover the second surface 12b, the fourth surface 12d, and the fifth surface 12e of the multilayer body 12. The fourth thin-film layer 34d may be spaced apart from the fourth outer plating region 40d or may overlap the fourth outer plating region 40d. The fourth thin-film layer 34d may be shaped so as to include a recess in the surface of the later-described fourth surface plating layer 36d.

Each of the first to fourth thin-film layers 34a to 34d is preferably a metal particle deposition formed by, for example, sputtering, vapor deposition, or the like. The thickness of the first to fourth thin-film layers 34a to 34d in the direction connecting the first and second surfaces 12a and 12b of the multilayer body 12 can be, for example, less than or equal to about 1 μm. Thus, the dimension of the multilayer ceramic capacitor 10 in the lamination direction x can be sufficiently reduced, and the multilayer ceramic capacitor 10 can be made thinner.

The dimension of the first to fourth thin-film layers 34a to 34d in the lamination direction x can be measured as follows. That is, in the case of forming the thin-film layers by deposition of metal particles, the measurement can be performed by using an X-ray fluorescence apparatus and calculating the thickness from the concentration of a predetermined element by a calibration curve method for the corresponding metal species. Alternatively, the measurement can also be performed by observing a section of components by FIB with a scanning microscope and measuring the thickness from the actual observed image.

In the case of forming the first to fourth thin-film layers 34a to 34d by, for example, a thin-film formation method, the first to fourth thin-film layers 34a to 34d are preferably made of metal, such as Cu or Ni, for example.

The first to fourth thin-film layers 34a to 34d can be configured based on their respective functions. For example, the first to fourth thin-film layers 34a to 34d preferably mainly include, for example, NiCr or NiCu in consideration of adhesion with the multilayer body 12. Furthermore, for example, the first to fourth thin-film layers 34a to 34d may have a multilayer structure and may include a two-layer structure of NiCr and NiCu.

The thin-film layers 34 may be formed by, for example, screen printing or the like and include a dielectric material and a metal component. The thin-film layers 34 are thus bonded to the ceramic of the multilayer body 12, and the bonding strength between the multilayer body 12 and the outer electrodes 30 can be further improved. In such a configuration, the thin-film layers 34 may include, in addition to the metal component, a ceramic component including the same main component as the inner dielectric layers 14a. The ceramic component included in the thin-film layers 34 can reduce the difference in coefficient of thermal expansion between the multilayer body 12 and the thin-film layers 34 and reduce the stress on the thin-film layers 34. However, for example, the thin-film layers 34 may include metals other than Cu or Ni as the metal component and may include a glass component in addition to the ceramic component. Examples of the glass component are oxides of barium (Ba), strontium (Sr), silicon (Si), calcium (Ca), Zn, Al, or boron (B). As another metal component, Mg, Cr, Sr, Al, Na, Fe, or the like may be included, for example. Furthermore, the thin-film layers 34 may each have a discontinuous shape. Having a discontinuous shape means that the thin-film layers 34 are each discontinuous when viewed in a direction perpendicular or substantially perpendicular to the longitudinal direction.

In the case of forming the thin-film layers 34 using a ceramic-including material, for example, a method can be used in which an image of a section is taken with a digital microscope (VHX-5000, by KEYENCE CORPORATION) after polishing of the section and then the thickness is calculated from the image of the section. In another method, a component's section with FIB is observed with a scanning microscope, and the thickness and the like are measured from the actual observed image.

### Surface Plating Layer

The surface plating layers 36 include the first surface plating layer 36a, the second surface plating layer 36b, the third surface plating layer 36c, and the fourth surface plating layer 36d.

The first surface plating layer 36a covers the first thin-film layer 34a and the first outer plating region 40a of the first underlying plating layer 32a, which is provided on the third surface 12c of the multilayer body 12.

The second surface plating layer 36b covers the second thin-film layer 34b and the second outer plating region 40b of the second underlying plating layer 32b, which is provided on the fourth surface 12d of the multilayer body 12.

The third surface plating layer 36c covers the third thin-film layer 34c and the third outer plating region 40c of the third underlying plating layer 32c, which is provided on the third surface 12c of the multilayer body 12.

The fourth surface plating layer 36d covers the fourth thin-film layer 34d and the fourth outer plating region 40d of the fourth underlying plating layer 32d, which is provided on the fourth surface 12d of the multilayer body 12.

The surface plating layers 36 preferably include at least one type of metal from Cu, Ni, Sn, Pb, Au, Ag, Pd, Bi, Zn, or the like or an alloy including the metal, for example. Preferably, the plating layers do not include glass.

The surface plating layers 36 may each include only Sn plating, for example, or may have a two-layer structure including Ni plating and Sn plating or a two-layer structure including Ni plating and Cu plating.

The thickness of the surface plating layers 36 is preferably greater than or equal to about 0.5 μm and less than or equal to about 10 μm, for example.

The proportion of metal per unit volume in the surface plating layers is, for example, preferably greater than or equal to about 99 vol %.

The thickness of each surface plating layer is, for example, preferably greater than or equal to about 0.5 μm and less than or equal to about 10.0 μm.

The dimension of the multilayer ceramic capacitor 10, which includes the multilayer body 12 and the outer electrodes 30, in the first direction y is referred to as the dimension L, the dimension of the multilayer ceramic capacitor 10, which includes the multilayer body 12 and the outer electrodes 30, in the lamination direction x is referred to as a dimension T, and the dimension of the multilayer ceramic capacitor 10, which includes the multilayer body 12 and the outer electrodes 30, in the second direction z is referred to as the dimension W.

As for the dimensions of the multilayer ceramic capacitor 10, for example, the dimension L in the first direction y is preferably greater than or equal to about 0.2 mm and less than or equal to about 3.2 mm, the dimension T in the lamination direction x is preferably greater than or equal to about 0.04 mm and less than or equal to about 0.22 mm, and the dimension W in the second direction z is preferably greater than or equal to about 0.2 mm and less than or equal to about 3.2 mm. The dimensions of the multilayer ceramic capacitor 10 preferably satisfy the following condition: about 0.85≤L/W≤about 1.00, for example. The multilayer body 12 thus has a tetragonal or substantially tetragonal shape, thus improving the mounting flexibility.

According to the multilayer ceramic capacitor 10 illustrated in FIG. 1, the first outer electrode 30a, the second outer electrode 30b, the third outer electrode 30c, and the fourth outer electrode 30d each include the underlying plating layer 32, the thin-film layer 34, and the surface plating layer 36. The underlying plating layers 32 include the outer plating regions 40 exposed on the third to sixth surfaces 12c to 12f, and the inner plating regions 42, which are arranged inside the third to sixth surfaces 12c to 12f and extended toward the first surface 12a. The multilayer body 12 includes an uneven surface due to the inner plating regions 42 arranged in such a manner. An anchor effect to the uneven surface can improve the adhesion between the thin-film layers 34 and the multilayer body 12. The multilayer ceramic capacitor 10 thus has higher humidity resistance.

### 3. Method for Manufacturing Multilayer Ceramic Capacitor

Hereinafter, an example of a method for manufacturing the multilayer ceramic capacitor according to the first example embodiment will be described.

First, dielectric sheets and conducting paste for inner electrodes are prepared. The dielectric sheets and conducting paste for inner electrodes include a binder and a solvent. The binder and solvent can be known materials.

Next, on the dielectric sheets, predetermined patterns are printed with the conducting paste for inner electrodes by, for example, ink-jet printing, screen printing, gravure printing, or the like. Thus, the dielectric sheets with the patterns for the first inner electrodes formed thereon and the dielectric sheets with the patterns for the second inner electrodes formed thereon are prepared. Then, the dielectric sheets with the patterns for the first inner electrodes formed thereon and the dielectric sheets with the patterns for the second inner electrodes formed thereon are laminated to form a portion that will define and function as the inner-layer portion 18.

In the case of forming print patterns for inner electrodes by gravure printing, for example, the desired inner electrodes can be formed by designing the gravure plate used in gravure printing with the graphic pattern of the first inner electrodes and modifying the gravure plate design to the structure corresponding to the graphic pattern of the second inner electrodes.

In the case of forming print patterns for inner electrodes by screen printing, for example, the desired inner electrodes can be formed by designing the mask for screen printing with the graphic pattern of the first inner electrodes and modifying the mask design to the structure corresponding to the graphic pattern of the second inner electrodes.

Next, a predetermined number of dielectric sheets with no inner electrode pattern printed thereon are laminated to form a portion that will define and function as the first outer-layer portion 20a on the first surface 12a side. Then, the portion prepared above to define and function as the inner-layer portion 18 is laminated thereon. On the portion that will define and function as the inner-layer portion 18, a predetermined number of dielectric sheets with no inner electrode pattern printed thereon are laminated to form a portion that will define and function as the second outer-layer portion 20b on the second surface 12b side. The multilayer sheet is thus prepared.

Next, the multilayer sheet is pressed in the lamination direction by, for example, isostatic press to prepare a multilayer block.

Subsequently, the multilayer block is cut to a predetermined size, and a multilayer chip is thus separated. In this process, the multilayer chip may undergo, for example, barrel polishing to have corner and edge portions rounded.

Next, the multilayer chip is sintered, thus preparing the multilayer body 12. The sintering temperature, which depends on the materials of the ceramic and inner electrodes, is, for example, preferably higher than or equal to about 900° C. and lower than or equal to about 1400° C.

In this process, the first extended electrode portions 24a of the first inner electrodes 16a and the third extended electrode portions 24c of the second inner electrodes 16b are exposed in the third surface 12c of the multilayer body 12. The second extended electrode portions 24b of the first inner electrodes 16a and the fourth extended electrode portions 24d of the second inner electrodes 16b are exposed in the fourth surface 12d of the multilayer body 12.

Then, the outer electrodes 30 are formed on the multilayer body 12.

First, holes for forming the inner plating regions 42 of the underlying plating layers 32 are formed. The method for forming these holes is not limited. The formation of the holes may be performed before sintering of the multilayer chip.

Next, the underlying plating layers 32 are formed on the surface of the multilayer body 12.

The first outer plating region 40a of the first underlying plating layer 32a is formed on the third surface 12c of the multilayer body 12, and the first inner plating region 42a of the first underlying plating layer 32a is formed in the first surface 12a.

The second outer plating region 40b of the second underlying plating layer 32b is formed on the fourth surface 12d of the multilayer body 12, and the second inner plating region 42b of the second underlying plating layer 32b is formed in the first surface 12a.

The third outer plating region 40c of the third underlying plating layer 32c is formed on the third surface 12c of the multilayer body 12, and the third inner plating region 42c of the third underlying plating layer 32c is formed in the first surface 12a.

The fourth outer plating region 40d of the fourth underlying plating layer 32d is formed on the fourth surface 12d of the multilayer body 12, and the fourth inner plating region 42d of the fourth underlying plating layer 32d is formed in the first surface 12a.

The underlying plating layers 32 are, for example, Cu plating herein and are formed by, for example, electrolytic plating or electroless plating. After plating, heat treatment is performed on the multilayer body 12 to evaporate residual water remaining within the plating film or in the interface between the multilayer body 12 and the underlying plating layers 32.

Next, the multilayer body 12 with the underlying plating layers 32 formed thereon is placed on a work table, and the thin-film layers 34 are formed on the first surface 12a by sputtering, for example.

Thereafter, the surface plating layers 36 are formed on the thin-film layers 34 and the outer plating regions 40, which are arranged on the surface of the multilayer body 12. To be more specific, as the surface plating layers 36, Ni plating layers and Sn plating layers are formed on the thin-film layers 34. The plating process can use either electrolytic plating or electroless plating. However, electroless plating needs pretreatment using a catalyst or the like to increase the plating deposition rate, and its process is complicated. Therefore, it is generally preferable to use electrolytic plating.

The multilayer ceramic capacitor 10 according to the present example embodiment illustrated in FIG. 1 can be manufactured as described above.

### B. Second Example Embodiment

### 1. Multilayer Ceramic Capacitor

An example e of a multilayer ceramic capacitor 110 according to a second example embodiment of the present invention will be described.

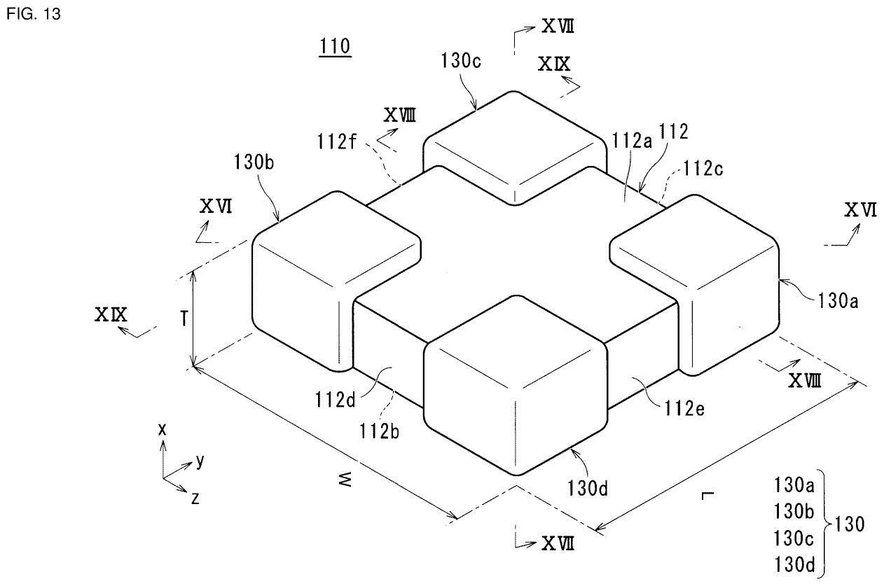

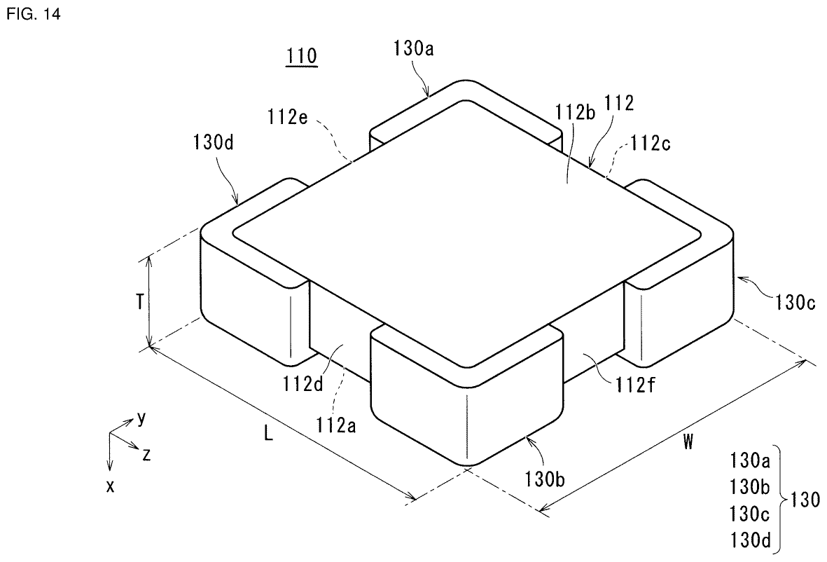

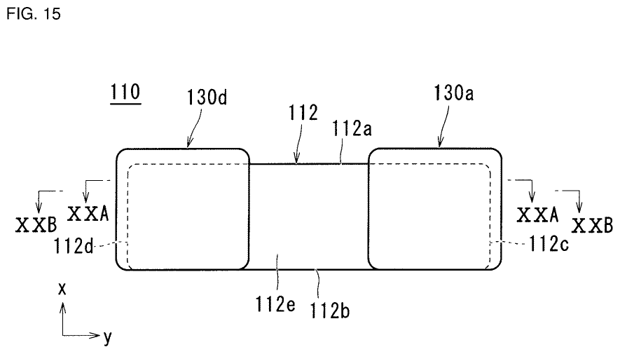

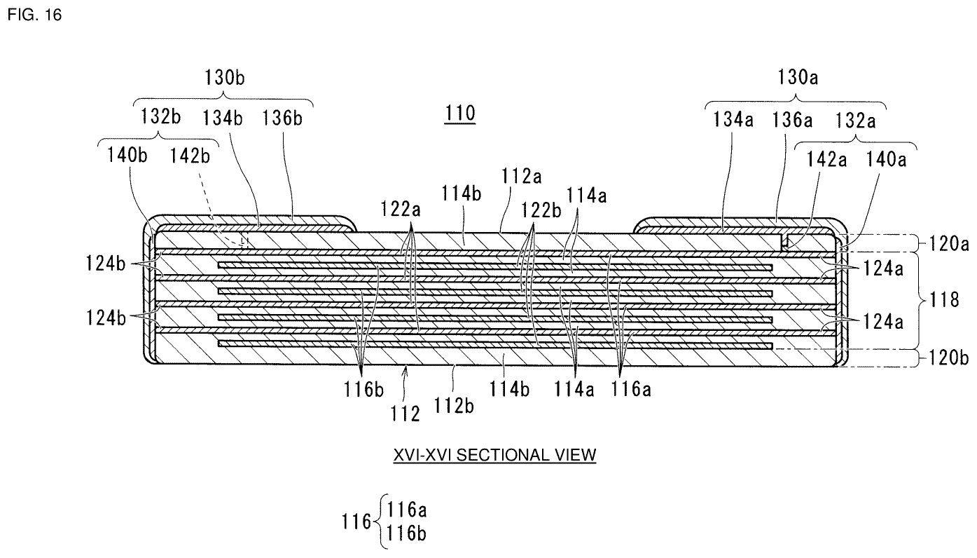

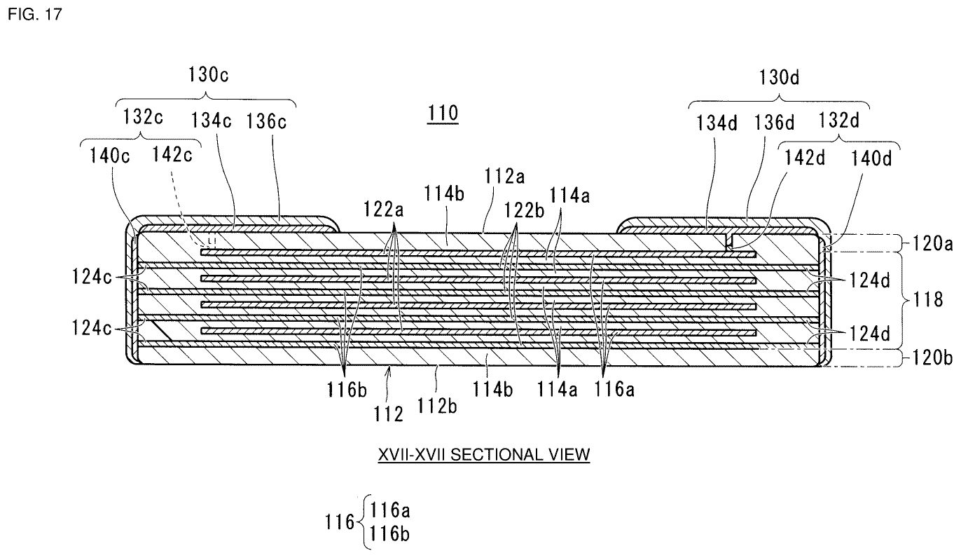

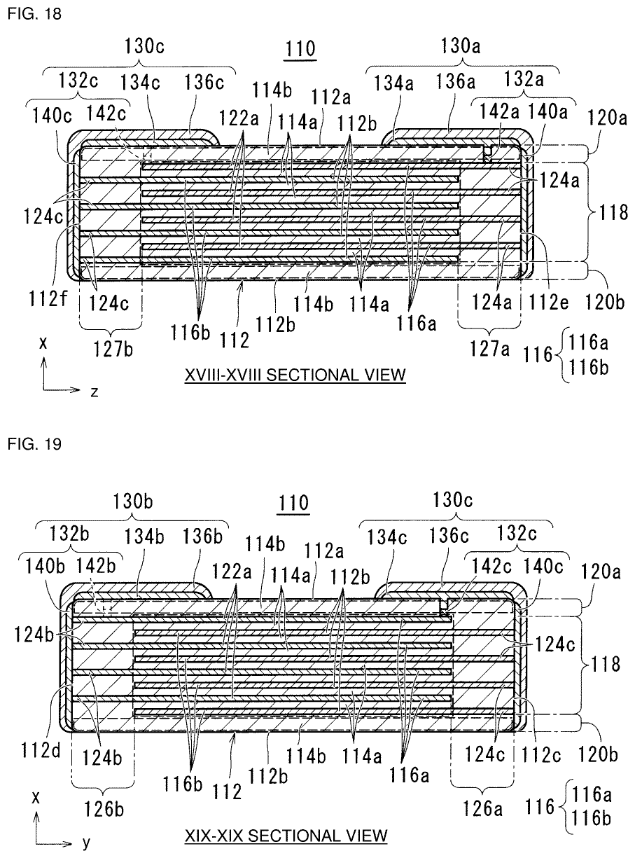

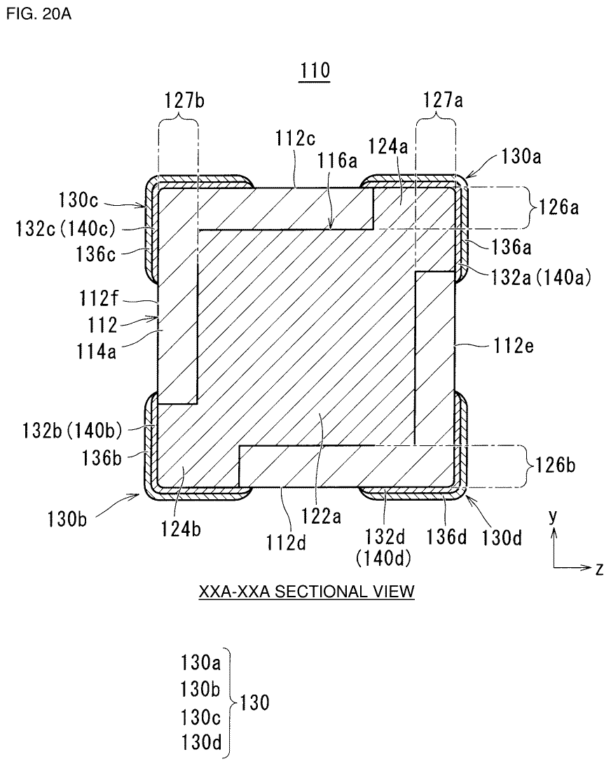

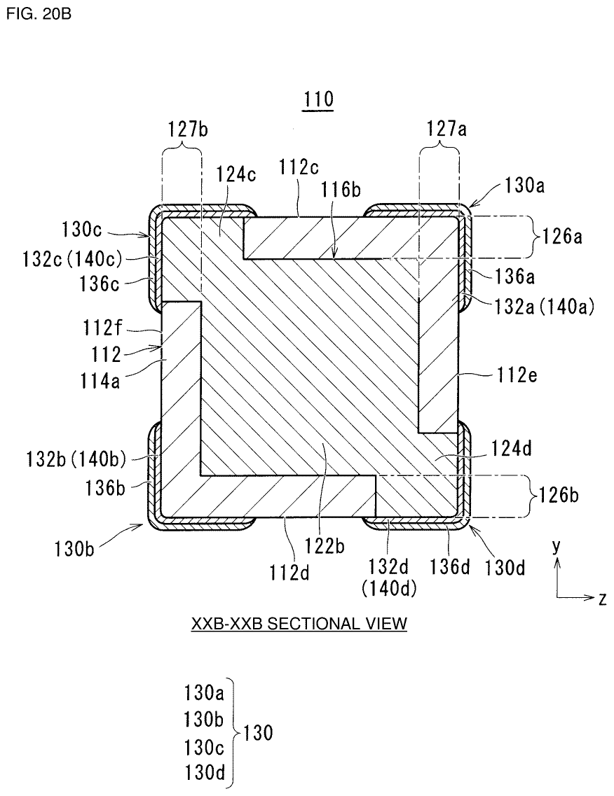

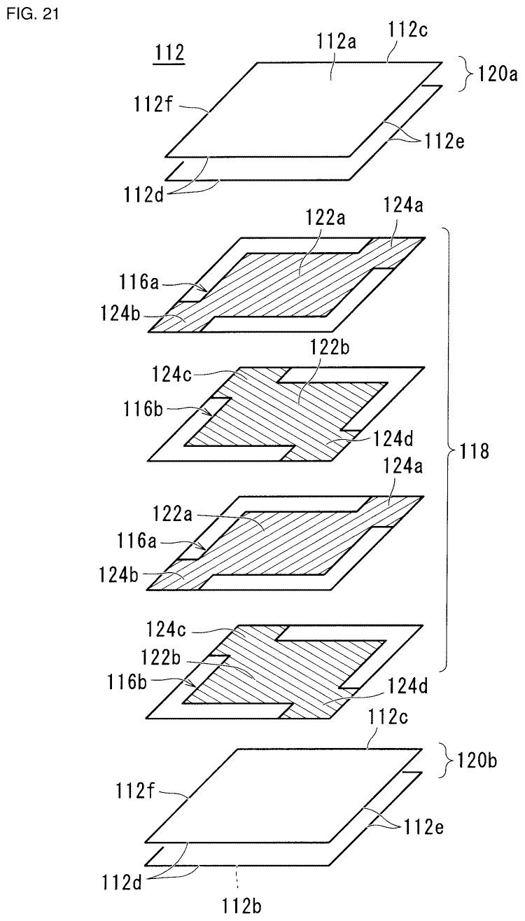

FIG. 13 is an external perspective view of an exemplary multilayer ceramic capacitor according to the second example embodiment of the present invention, as seen from one side. FIG. 14 is an external perspective view of the exemplary multilayer ceramic capacitor according to the second example embodiment of the present invention, as seen from the other side. FIG. 15 is a front view of the exemplary multilayer ceramic capacitor according to the second example embodiment of the present invention. FIG. 16 is a schematic sectional view along a line XVI-XVI in FIG. 13. FIG. 17 is a schematic sectional view along a line XVII-XVII in FIG. 13. FIG. 18 is a schematic sectional view along a line XVIII-XVIII in FIG. 13. FIG. 19 is a schematic sectional view along a line XIX-XIX in FIG. 13. FIG. 20A is a schematic sectional view along a line XXA-XXA in FIG. 15. FIG. 20B is a schematic sectional view along a line XXB-XXB in FIG. 15. FIG. 21 is an exploded perspective view of the multilayer body illustrated in FIG. 16. The configurations identical to or corresponding to those in FIGS. 1 to 7 are given the same reference numerals, and the detailed description thereof will be omitted.

The multilayer ceramic capacitor 110 includes a multilayer body 112 and outer electrodes 130.

### Multilayer Body

The multilayer body 112 includes plural dielectric layers 114 and plural inner electrodes 116. The dielectric layers 114 include inner dielectric layers 114a and outer dielectric layers 114b. The inner electrodes 116 include first inner electrodes 116a and second inner electrodes 116b.

The multilayer body 112 includes an inner-layer portion 118, a first outer-layer portion 120a, which is located on a first surface 112a side, and a second outer-layer portion 120b, which is located on a second surface 112b side.

The first outer-layer portion 120a is located on the first surface 112a side of the multilayer body 112 and is an assembly including plural outer dielectric layers 114b located between the first surface 112a and the inner electrode 116 closest to the first surface 112a.

The second outer-layer portion 120b is located on the second surface 112b side of the multilayer body 112 and is an assembly including plural outer dielectric layers 114b located between the second surface 112b and the inner electrode 116 closest to the second surface 112b.

The region sandwiched between the first outer-layer portion 120a and the second outer-layer portion 120b is referred to as the inner-layer portion 118.

The inner-layer portion 118 includes the first inner electrodes 116a, the second inner electrodes 116b, and the inner dielectric layers 114a. One end of each first inner electrode 116a is exposed in a third surface 112c while the other end thereof is exposed in a fourth surface 112d. One end of each second inner electrode 116b is exposed in the third surface 112c while the other end thereof is exposed in the fourth surface 112d.

The materials and the like of the dielectric layers 114 are the same as those of the dielectric layers 14, and the description thereof is omitted.

### Inner Electrode

The inner electrodes 116 include the plural first inner electrodes 116a and the plural second inner electrodes 116b. The first and second inner electrodes 116a and 116b are alternately laminated with the dielectric layers 114 interposed therebetween.

The first inner electrodes 116a are provided on the surfaces of the respective inner dielectric layers 114a. Each first inner electrode 116a faces the first and second surfaces 112a and 112b and includes a first opposing electrode portion 122a, which faces the corresponding second inner electrode 116b. The first inner electrodes 116a are laminated in the direction connecting the first and second surfaces 112a and 112b.

The first inner electrodes 116a are extended through first extended electrode portions 124a to the third surface 112c and a fifth surface 112e of the multilayer body 112 and are extended through second extended electrode portions 124b to the fourth surface 112d and a sixth surface 112f of the multilayer body 112. The width of the first extended electrode portions 124a extended to the third surface 112c may be equal or substantially equal to the width thereof extended to the fifth surface 112e. The width of the second extended electrode portions 124b extended to the fourth surface 112d is equal or substantially equal to the width thereof extended to the sixth surface 112f.

The first inner electrodes 116a are continuously extended through the first extended electrode portions 124a to the third and fifth surfaces 112c and 112e of the multilayer body 112 and are continuously extended through the second extended electrode portions 124b to the fourth and sixth surfaces 112d and 112f of the multilayer body 112. However, the first inner electrodes 116a are not limited to such a configuration and may be extended discontinuously.

The second inner electrodes 116b are provided on the surfaces of the inner dielectric layers 114a different from the inner dielectric layers 114a on which the first inner electrodes 116a are provided. Each second inner electrode 116b faces the first and second surfaces 112a and 112b and includes a second opposing electrode portion 122b, which faces the corresponding first inner electrode 116a. The second inner electrodes 116b are laminated in the direction connecting the first and second surfaces 112a and 112b.

The second inner electrodes 116b are extended through third extended electrode portions 124c to the third and sixth surfaces 112c and 112f of the multilayer body 112 and are extended through fourth extended electrode portions 124d to the fourth and fifth surfaces 112d and 112e of the multilayer body 112. The width of the third extended electrode portions 124c extended to the third surface 112c is equal or substantially equal to the width thereof extended to the sixth surface 112f. The width of the fourth extended electrode portions 124d extended to the fourth surface 112d is equal or substantially equal to the width thereof extended to the fifth surface 112e.

The second inner electrodes 116b are continuously extended through the third extended electrode portions 124c to the third and sixth surfaces 112c and 112f of the multilayer body 112 and are continuously extended through the fourth extended electrode portions 124d to the fourth and fifth surfaces 112d and 112e of the multilayer body 112. However, the second inner electrodes 116b are not limited to such a configuration and may be extended discontinuously.

When the multilayer ceramic capacitor 110 is viewed in the lamination direction x, preferably, a straight line connecting the first and second extended electrode portions 124a and 124b of the first inner electrodes 116a intersects with a straight line connecting the third and fourth extended electrode portions 124c and 124d of the second inner electrodes 116b.

As illustrated in FIG. 19, the multilayer body 112 includes a side portion (W gap) 126a of the multilayer body 112, which is located between one end in the first direction y, of the second opposing electrode portion 122b of each second inner electrode 116b and the third surface 112c, and a side portion (W gap) 126b of the multilayer body 112, which is located between the other end in the first direction y, of the first opposing electrode portion 122a of each first inner electrode 116a and the fourth surface 112d.

As illustrated in FIG. 18, furthermore, the multilayer body 112 includes an end portion (L gap) 127a of the multilayer body 112, which is located between one end in the second direction z, of the second opposing electrode portion 122b of each second inner electrode 116b and the fifth surface 112e, and a side portion (L gap) 127b of the multilayer body 112, which is located between the other end in the second direction z, of the first opposing electrode portion 122a of each first inner electrode 116a and the sixth surface 112f.

### Outer Electrode

In the multilayer ceramic capacitor 110 according to the second example embodiment, the outer electrodes 130 cover the first surface 112a of the multilayer body 112 and do not cover the second surface 112b.

The outer electrodes 130 are provided on the multilayer body 112 as illustrated in FIGS. 13 to 19.

The outer electrodes 130 include plural outer electrodes 130 coupled to the first inner electrodes 116a and the second inner electrodes 116b. The outer electrodes 130 include a first outer electrode 130a, a second outer electrode 130b, a third outer electrode 130c, and a fourth outer electrode 130d.

The first outer electrode 130a is provided on the third surface 112c and the fifth surface 112e so as to cover the first extended electrode portions 124a of the first inner electrodes 116a. The first outer electrode 130a is further provided so as to cover a portion of the first surface 112a. The first outer electrode 130a is electrically coupled to the first extended electrode portions 124a of the first inner electrodes 116a.

The second outer electrode 130b is provided on the fourth surface 112d and the sixth surface 112f so as to cover the second extended electrode portions 124b of the first inner electrodes 116a. The second outer electrode 130b is further provided so as to cover a portion of the first surface 112a. The second outer electrode 130b is electrically coupled to the second extended electrode portions 124b of the first inner electrodes 116a.

The third outer electrode 130c is provided on the third surface 112c and the sixth surface 112f so as to cover the third extended electrode portions 124c of the second inner electrodes 116b. The third outer electrode 130c is further provided so as to cover a portion of the first surface 112a. The third outer electrode 130c is electrically coupled to the third extended electrode portions 124c of the second inner electrodes 116b.

The fourth outer electrode 130d is provided on the fourth surface 112d and the fifth surface 112e so as to cover the fourth extended electrode portions 124d of the second inner electrodes 116b. The fourth outer electrode 130d is further provided so as to cover a part of the first surface 112a. The fourth outer electrode 130d is electrically coupled to the fourth extended electrode portions 124d of the second inner electrodes 116b.

Within the multilayer body 112, the first opposing electrode portions 122a of the first inner electrodes 116a and the second opposing electrode portions 122b of the second inner electrodes 116b face each other with the inner dielectric layers 114a interposed therebetween to generate capacitance. This can provide capacitance between the first and second outer electrodes 130a and 130b, to which the first inner electrodes 116a are coupled, and between the third and fourth outer electrodes 130c and 130d, to which the second inner electrodes 116b are coupled. The capacitor characteristics are thus provided.

The first outer electrode 130a, the second outer electrode 130b, the third outer electrode 130c, and the fourth outer electrode 130d each include an underlying plating layer 132, a thin-film layer 134, and a surface plating layer 136.

### Underlying Plating Layer

The underlying plating layers 132 include outer plating regions 140, which are arranged on the third to sixth surfaces 112c to 112f, and inner plating regions 142, which are arranged inside the third to sixth surfaces 112c to 112f and are extended toward the first surface 112a. That is, the inner plating regions 142 are extended from the inner electrode 116 closest to the first surface 112a in the lamination direction x, toward the first surface 112a. Hereinafter, the specific configuration of the underlying plating layers 132 will be described.

A first underlying plating layer 132a includes a first outer plating region 140a and a first inner plating region 142a.

The first outer plating region 140a is arranged on the surfaces of the third and fifth surfaces 112c and 112e of the multilayer body 112 so as to cover the first extended electrode portions 124a of the first inner electrodes 116a exposed in the third and fifth surfaces 112c and 112e of the multilayer body 112.

The first inner plating region 142a is arranged in a region of the first surface 112a located at a corner portion defined by the third and fifth surfaces 112c and 112e and is extended from the inner electrode 116 closest to the first surface 112a in the lamination direction x, toward the first surface 112a. As illustrated in FIG. 16, the distance between the first surface 112a and the inner electrode 16 closest to the first surface 112a is longer than the dimension of the first inner plating region 142a in the lamination direction x. The first inner plating region 142a is recessed from the first surface 112a.

When the distance between the first surface 112a and the inner electrode 116 closest to the first surface 112a is longer than the dimension of the first inner plating region 142a in the lamination direction x, the distance between the first inner plating region 142a and the first surface 112a in the lamination direction x is, for example, preferably less than or equal to about 0.5 μm. An exposed width of the first inner plating region 142a is, for example, preferably greater than or equal to about 0.02 μm and less than or equal to about 3.1 μm. This can improve the bonding strength between the first thin-film layers 134a and the multilayer body 112.

On the other hand, the first inner plating region 142a may, not illustrated, protrude from the first surface 112a. In such a configuration, since the distance between the first surface 112a and the inner electrode 116 closest to the first surface 112a is shorter than the dimension of the first inner plating region 142a in the lamination direction x, the first inner plating region 142a protrudes from the first surface 112a. When the distance between the first surface 112a and the inner electrode 116 closest to the first surface 112a is shorter than the dimension of the first inner plating region 142a in the lamination direction x, therefore, the first inner plating region 142a protrudes in the first surface 112a and covers the first surface 112a. This can improve the humidity resistance.

As described above, the multilayer body 112 includes an uneven surface due to the first inner plating region 142a. An anchor effect to the uneven surface can further improve the adhesion between the first thin-film layer 134a and the multilayer body 112.

The surface roughness ratio of the first outer-layer portion 120a, which faces the first inner plating region 142a, is, for example, preferably greater than or equal to about 1.5. The surface roughness ratio indicates the ratio of the actual path length to the straight-line length.

The other configurations of the aforementioned first inner plating region 142a are the same as those of the first inner plating region 42a.

A second underlying plating layer 132b includes a second outer plating region 140b and a second inner plating region 142b.

The second outer plating region 140b is arranged on the surface of the fourth surface 112d of the multilayer body 112 so as to cover the second extended electrode portions 124b of the first inner electrodes 116a exposed in the fourth and sixth surfaces 112d and 112f of the multilayer body 112.

The second inner plating region 142b is arranged in a region of the first surface 112a located at a corner portion defined by the fourth and sixth surfaces 112d and 112f and is extended from the inner electrode 116 closest to the first surface 112a in the lamination direction x, toward the first surface 112a.

Similarly to the first inner plating region 142a, the second inner plating region 142b may protrude from the first surface 112a or be recessed from the first surface 112a.

When the distance between the first surface 112a and the inner electrode 116 closest to the first surface 112a is shorter than the dimension of the second inner plating region 142b in the lamination direction x, the second inner plating region 142b protrudes from the first surface 112a. On the other hand, when the distance between the first surface 112a and the inner electrode 116 closest to the first surface 112a is longer than the dimension of the second inner plating region 142b in the lamination direction x, the second inner plating region 142b is recessed from the first surface 112a. When the multilayer body 112 includes an uneven surface due to the second inner plating region 142b, its anchor effect can further improve the adhesion between the second thin-film layer 134b and the multilayer body 112.

The other configurations of the second inner plating region 142b are the same or substantially the same as those of the first inner plating region 142a.

A third underlying plating layer 132c includes a third outer plating region 140c and a third inner plating region 142c.

The third outer plating region 140c is arranged on the surface of the third surface 112c of the multilayer body 112 so as to cover the third extended electrode portions 124c of the second inner electrodes 116b exposed in the third and sixth surfaces 112c and 112f of the multilayer body 112.

The third inner plating region 142c is arranged in a region of the first surface 112a located at a corner portion defined by the third and sixth surfaces 112c and 112f and is extended from the inner electrode 116 closest to the first surface 112a in the lamination direction x, toward the first surface 112a.

Similarly to the first inner plating region 142a, the third inner plating region 142c may protrude from the first surface 112a or be recessed from the first surface 112a.

When the distance between the first surface 112a and the inner electrode 116 closest to the first surface 112a is shorter than the dimension of the third inner plating region 142c in the lamination direction x, the third inner plating region 142c protrudes from the first surface 112a. On the other hand, when the distance between the first surface 112a and the inner electrode 116 closest to the first surface 112a is longer than the dimension of the third inner plating region 142c in the lamination direction x, the third inner plating region 142c is recessed from the first surface 112a. When the multilayer body 112 includes an uneven surface due to the third inner plating region 142c, its anchor effect can further improve the adhesion between the third thin-film layer 134c and the multilayer body 112.

The other configurations of the third inner plating region 142c are the same or substantially the same as those of the first inner plating region 142a.

A fourth underlying plating layer 132d includes a fourth outer plating region 140d and a fourth inner plating region 142d.

The fourth outer plating region 140d is arranged on the surface of the fourth surface 112d of the multilayer body 112 so as to cover the fourth extended electrode portions 124d of the second inner electrodes 116b exposed in the fourth and fifth surfaces 112d and 112e of the multilayer body 112.

The fourth inner plating region 142d is arranged in a region of the first surface 112a located at a corner portion defined by the fourth and fifth surfaces 112d and 112e and is extended from the inner electrode 116 closest to the first surface 112a in the lamination direction x, toward the first surface 112a. Similarly to the first inner plating region 142a, the fourth inner plating region 142d may protrude from the first surface 112a or be recessed from the first surface 112a.

When the distance between the first surface 112a and the inner electrode 116 closest to the first surface 112a is shorter than the dimension of the fourth inner plating region 142d in the lamination direction x, the fourth inner plating region 142d protrudes from the first surface 112a. On the other hand, when the distance between the first surface 112a and the inner electrode 116 closest to the first surface 112a is longer than the dimension of the fourth inner plating region 142d in the lamination direction x, the fourth inner plating region 142d is recessed from the first surface 112a. When the multilayer body 112 includes an uneven surface due to the fourth inner plating region 142d, its anchor effect can further improve the adhesion between the fourth thin-film layer 134d and the multilayer body 112.

The other configurations of the fourth inner plating region 142d are the same or substantially the same as those of the first inner plating region 142a.

The outer plating regions 140 and the inner plating regions 142 are preferably made of the same type of metal component. The outer plating regions 140 and the inner plating regions 142, of the underlying plating layers 132, preferably include, for example, Cu plating although it depends on the connectivity with the inner electrodes 116.

The upper end of the first underlying plating layer 132a of the first outer electrode 130a may overlap the underside of the first thin-film layer 134a on the edge portion defined by the first and third surfaces 112a and 112c of the multilayer body 112 and the edge portion defined by the first and fifth surfaces 112a and 112e of the multilayer body 112 or be spaced apart from the first thin-film layer 134a. In such a configuration, the first outer plating region 140a may cover the edge portion defined by the third and fifth surfaces 112c and 112e.

The upper end of the second underlying plating layer 132b of the second outer electrode 130b may overlap the underside of the second thin-film layer 134b on the edge portion defined by the first and fourth surfaces 112a and 112d of the multilayer body 112 and the edge portion defined by the first and sixth surfaces 112a and 112f of the multilayer body 112 or be spaced apart from the second thin-film layer 134b. In such a configuration, the second outer plating region 140b may cover the edge portion defined by the fourth surface 112d and the sixth surface 112f.

The upper end of the third underlying plating layer 132c of the third outer electrode 130c may overlap the underside of the third thin-film layer 134c on the edge portion defined by the first and third surfaces 112a and 112c of the multilayer body 112 and the edge portion defined by the first and sixth surfaces 112a and 112f of the multilayer body 112 or be spaced apart from the third thin-film layer 134c. In such a configuration, the third outer plating region 140c may cover the edge portion defined by the third and sixth surfaces 112c and 112f.

The upper end of the fourth underlying plating layer 132d of the fourth outer electrode 130d may overlap the underside of the fourth thin-film layer 134d on the edge portion defined by the first and fourth surfaces 112a and 112d of the multilayer body 112 and the edge portion defined by the first and fifth surfaces 112a and 112e of the multilayer body 112 or be spaced apart from the fourth thin-film layer 134d. In such a configuration, the fourth outer plating region 140d may cover the edge portion defined by the fourth and fifth surfaces 112d and 112e.

The underlying plating layers 132 include, for example, Cu as a main metal component. When the first inner electrodes 116a and the second inner electrodes 116b include Ni, for example, the underlying plating layers 132 preferably include Cu plating, which has good adhesion with Ni.

The underlying plating layers 132 are formed by plating growth from the inner electrodes 116.

The thickness of each underlying plating layer 132 is, for example, preferably greater than or equal to about 0.5 μm and less than or equal to about 10.0 μm.

The multilayer ceramic capacitor 110 illustrated in FIG. 13 has the same or substantially the same advantageous effects as the multilayer ceramic capacitor 10 according to the first example embodiment.

### 2. Method for Manufacturing Multilayer Ceramic Capacitor

Hereinafter, an example of a method for manufacturing the multilayer ceramic capacitor according to the second example embodiment will be described.

First, dielectric sheets and conducting paste for inner electrodes are prepared. The dielectric sheets and conducting paste for inner electrodes contain a binder and a solvent. The binder and solvent can be known materials.

Next, on the dielectric sheets, predetermined patterns are printed with the conducting paste for inner electrodes by, for example, ink-jet printing, screen printing, gravure printing, or the like. Thus, the dielectric sheets with the patterns for the first inner electrodes formed thereon and the dielectric sheets with the patterns for the second inner electrodes formed thereon are prepared. Then, the dielectric sheets with the patterns for the first inner electrodes formed thereon and the dielectric sheets with the patterns for the second inner electrodes formed thereon are laminated to form a portion that will define and function as the inner-layer portion 118.

Next, a predetermined number of dielectric sheets with no inner electrode pattern printed thereon are laminated to form a portion that will define and function as the first outer-layer portion 120a on the first surface 112a side. Then, the portion prepared above to define and function as the inner-layer portion 118 is laminated thereon. On the portion that will define and function as the inner-layer portion 118, a predetermined number of dielectric sheets with no inner electrode pattern printed thereon are laminated to form a portion that will define and function as the second outer-layer portion 120b on the second surface 112b side. The multilayer sheet is thus prepared.

Next, the multilayer sheet is pressed in the lamination direction by, for example, isostatic pressing to prepare a multilayer block.

Subsequently, the multilayer block is cut to a predetermined size, and a multilayer chip is thus separated. In this process, the multilayer chip may undergo, for example, barrel polishing to have corner and edge portions rounded.

Next, the multilayer chip is sintered, thus preparing the multilayer body 112. The sintering temperature, which depends on the materials of the ceramic and inner electrodes, is, for example, preferably higher than or equal to about 900° C. and lower than or equal to about 1400° C.

In this process, the first extended electrode portions 124a of the first inner electrodes 116a and the third extended electrode portions 124c of the second inner electrodes 116b are exposed in the third surface 112c of the multilayer body 112. The second extended electrode portions 124b of the first inner electrodes 116a and the fourth extended electrode portions 124d of the second inner electrodes 116b are exposed in the fourth surface 112d of the multilayer body 112.

The first extended electrode portions 124a of the first inner electrodes 116a and the fourth extended electrode portions 124d of the second inner electrodes 116b are exposed in the fifth surface 112e of the multilayer body 112. The second extended electrode portions 124b of the first inner electrodes 116a and the third extended electrode portions 124c of the second inner electrodes 116b are exposed in the sixth surface 112f of the multilayer body 112.

Then, the outer electrodes 130 are formed on the multilayer body 112.

First, holes for forming the inner plating regions 142 of the underlying plating layers 132 are formed. The method for forming these holes is not limited. The formation of the holes may be performed before sintering of the multilayer chip.

Next, the underlying plating layers 132 are formed on the surface of the multilayer body 112.

The first outer plating region 140a of the first underlying plating layer 132a is formed on the third and fifth surfaces 112c and 112e of the multilayer body 112, and the first inner plating region 142a of the first underlying plating layer 132a is formed in the first surface 112a.

The second outer plating region 140b of the second underlying plating layer 132b is formed on the fourth and sixth surfaces 112d and 112f of the multilayer body 112, and the second inner plating region 142b of the second underlying plating layer 132b is formed in the first surface 112a.

The third outer plating region 140c of the third underlying plating layer 132c is formed on the third and sixth surfaces 112c and 112f of the multilayer body 112, and the third inner plating region 142c of the third underlying plating layer 132c is formed in the first surface 112a.

The fourth outer plating region 140d of the fourth underlying plating layer 132d is formed on the fourth and fifth surfaces 112d and 112e of the multilayer body 112, and the fourth inner plating region 142d of the fourth underlying plating layer 132d is formed in the first surface 112a.

The underlying plating layers 132 are, for example, Cu plating herein and are formed by electrolytic plating or electroless plating. After plating, heat treatment is performed on the multilayer body 112 to evaporate residual water remaining within the plating film or in the interface between the multilayer body 112 and the underlying plating layers 132.

Next, the multilayer body 112 with the underlying plating layers 132 formed thereon is placed on a work table, and the thin-film layers 134 are formed on the first surface 112a and the second surface 112b by sputtering, for example.

Thereafter, the surface plating layers 136 are formed on the thin-film layers 134 and the surface of the multilayer body 112. To be more specific, as the surface plating layers 136, for example, Ni plating layers and Sn plating layers are formed on the thin-film 134. The plating process can use either electrolytic plating or electroless plating. However, electroless plating needs pretreatment using a catalyst or the like to increase the plating deposition rate, and its process is complicated. Therefore, it is generally preferable to use electrolytic plating.

In this process, due to the surface plating layers 136, a portion of the outer electrodes 130 disposed on each side surface to which no inner electrodes 116 are extended is formed in a U-shape so as to cover both short sides of the side face to which no inner electrodes 116 are extended and portions from end portions of the both short sides to the middle of both long sides.

The multilayer ceramic capacitor 110 as illustrated in FIG. 13 is manufactured as described above.

### C. Third Example Embodiment

### 1. Multilayer Ceramic Capacitor

An example of a multilayer ceramic capacitor 210 according to a third example embodiment of the present invention will be described.

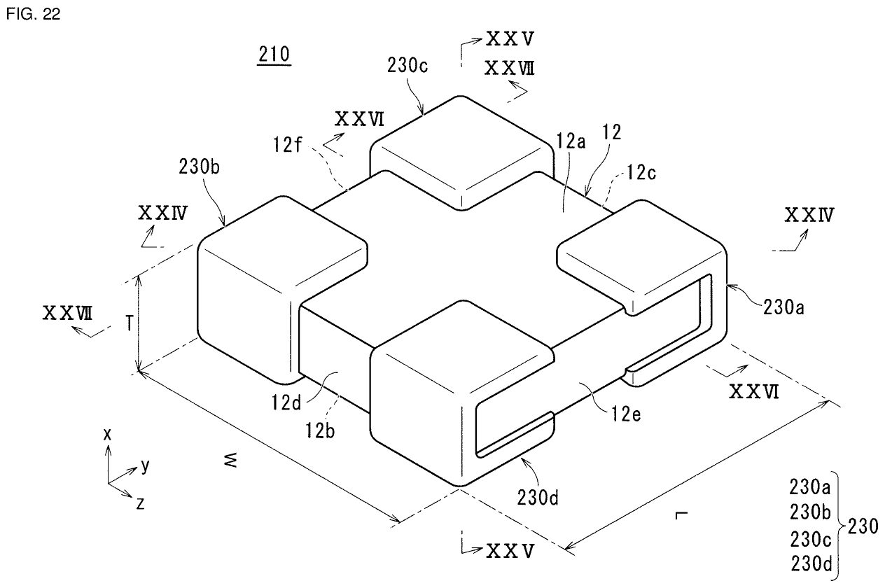

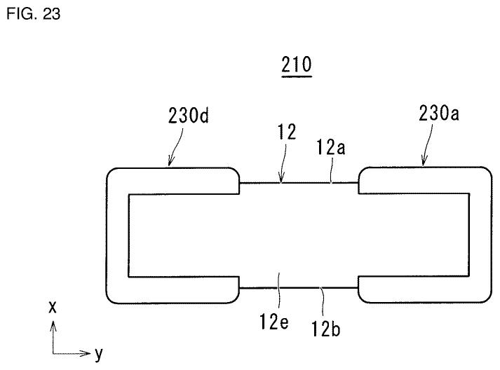

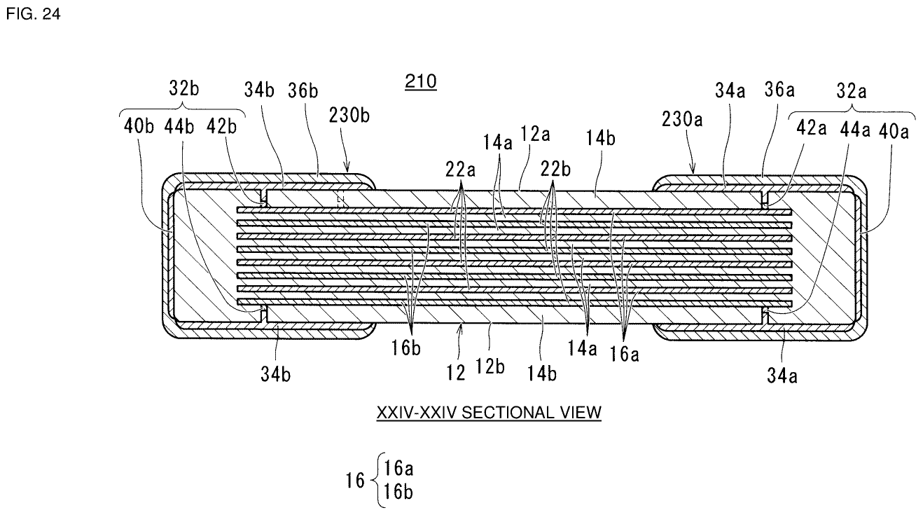

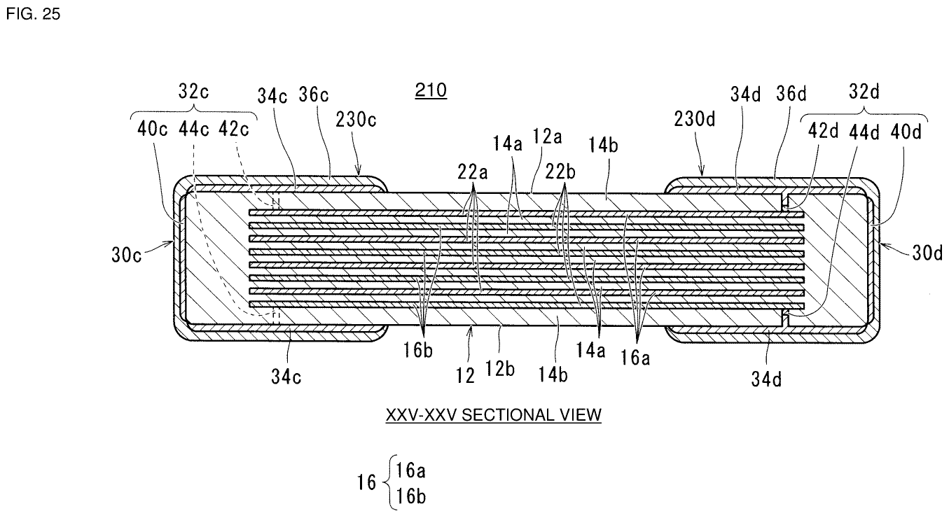

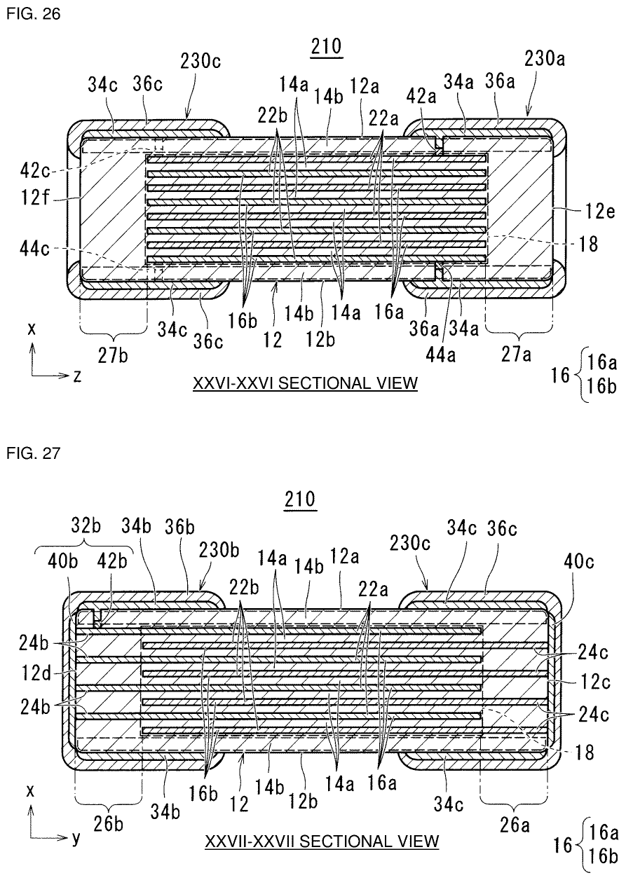

FIG. 22 is an external perspective view of an exemplary multilayer ceramic capacitor according to the third example embodiment of the present invention. FIG. 23 is a front view of the exemplary multilayer ceramic capacitor according to the third example embodiment of the present invention. FIG. 24 is a schematic sectional view along a line XXIV-XXIV in FIG. 22. FIG. 25 is a schematic sectional view along a line XXV-XXV in FIG. 22. FIG. 26 is a schematic sectional view along a line XXVI-XXVI in FIG. 22. FIG. 27 is a schematic sectional view along a line XXVII-XXVII in FIG. 22. The configurations identical to or corresponding to those in FIGS. 1 to 7 are given the same reference numerals, and the detailed description thereof will be omitted.

The multilayer ceramic capacitor 210 includes the multilayer body 12 and plural outer electrodes 230.

### Multilayer Body

In the multilayer ceramic capacitor 210 according to the third example embodiment, the multilayer body 12 has the same or substantially the same configuration as the multilayer body 12 of the first example embodiment of the present invention illustrated in FIG. 1.

### Inner Electrode

The inner electrodes 16 include the plural first inner electrodes 16a and the plural second inner electrodes 16b. The first and second inner electrodes 16a and 16b are alternately laminated with the dielectric layers 14 interposed therebetween.

The first inner electrodes 16a are disposed on the surfaces of the respective inner dielectric layers 14a. Each first inner electrode 16a faces the first surface 12a and the second surface 12b and includes the first opposing electrode portion 22a, which faces the corresponding second inner electrode 16b. The first inner electrodes 16a are laminated in the direction connecting the first and second surfaces 12a and 12b.

The first inner electrodes 16a are extended through the first extended electrode portions 24a to the third surface 12c of the multilayer body 12 and are extended through the second extended electrode portions 24b to the fourth surface 12d of the multilayer body 12. The first extended electrode portions 24a are extended on the fifth surface 12e side of the multilayer body 12, and the second extended electrode portions 24b are extended on the sixth surface 12f side of the multilayer body 12.

The second inner electrodes 16b are disposed on the surfaces of the inner dielectric layers 14a different from the inner dielectric layers 14a on which the first inner electrodes 16a are disposed. Each second inner electrode 16b faces the first surface 12a and the second surface 12b and includes the second opposing electrode portion 22b, which faces the corresponding first inner electrode 16a. The second inner electrodes 16b are laminated in the direction connecting the first and second surfaces 12a and 12b.

The second inner electrodes 16b are extended through the third extended electrode portions 24c to the third surface 12c of the multilayer body 12 and are extended through the fourth extended electrode portions 24d to the fourth surface 12d of the multilayer body 12. The third extended electrode portions 24c are extended on the sixth surface 12f side of the multilayer body 12, and the fourth extended electrode portions 24d are extended on the fifth surface 12e side of the multilayer body 12.

The first inner electrodes 16a and the second inner electrodes 16b are not exposed in the fifth and sixth surfaces 12e and 12f of the multilayer body 12.

When the multilayer ceramic capacitor 210 is viewed in the lamination direction x, preferably, a straight line connecting the first and second extended electrode portions 24a and 24b of the first inner electrodes 16a intersects with a straight line connecting the third and fourth extended electrode portions 24c and 24d of the second inner electrodes 16b.

Furthermore, in the surfaces 12c, 12d, 12e, and 12f of the multilayer body 12, the first extended electrode portions 24a of the first inner electrodes 16a and the fourth extended electrode portions 24d of the second inner electrodes 16b are preferably extended to the positions opposite to each other. The second extended electrode portions 24b of the first inner electrodes 16a and the third extended electrode portions 24c of the second inner electrodes 16b are preferably extended to the positions opposite to each other.

As illustrated in FIG. 27, the multilayer body 12 includes the side portion (W gap) 26a of the multilayer body 12, which is located between one end in the first direction y, of the second opposing electrode portion 22b of each second inner electrode 16b and the third surface 12c, and the side portion (W gap) 26b of the multilayer body 12, which is located between the other end in the first direction y, of the first opposing electrode portion 22a of each first inner electrode 16a and the fourth surface 12d.

As illustrated in FIG. 26, furthermore, the multilayer body 12 includes the end portion (L gap) 27a of the multilayer body 12, which is located between one end in the second direction z, of the second opposing electrode portion 22b of each second inner electrode 16b and the fifth surface 12e, and the side portion (L gap) 27b of the multilayer body 12, which is located between the other end in the second direction z, of the first opposing electrode portion 22a of each first inner electrode 16a and the sixth surface 12f.

### Outer Electrode

The outer electrodes 230 are disposed on the multilayer body 12 as illustrated in FIGS. 22 to 27.

The outer electrodes 230 include plural outer electrodes 230 coupled to the first inner electrodes 16a and the second inner electrodes 16b. The outer electrodes 230 include a first outer electrode 230a, a second outer electrode 230b, a third outer electrode 230c, and a fourth outer electrode 230d.

The first outer electrode 230a is disposed on the third surface 12c so as to cover the first extended electrode portions 24a of the first inner electrodes 16a. The first outer electrode 230a is further disposed so as to cover a portion of the first surface 12a and a portion of the second surface 12b. The first outer electrode 230a is electrically coupled to the first extended electrode portions 24a of the first inner electrodes 16a.

The second outer electrode 230b is disposed on the fourth surface 12d so as to cover the second extended electrode portions 24b of the first inner electrodes 16a. The second outer electrode 230b is further disposed so as to cover a portion of the first surface 12a and a portion of the second surface 12b. The second outer electrode 230b is electrically coupled to the second extended electrode portions 24b of the first inner electrodes 16a.

The third outer electrode 230c is disposed on the third surface 12c so as to cover the third extended electrode portions 24c of the second inner electrodes 16b. The third outer electrode 230c is further disposed so as to cover a portion of the first surface 12a and a portion of the second surface 12b. The third outer electrode 230c is electrically coupled to the third extended electrode portions 24c of the second inner electrodes 16b.

The fourth outer electrode 230d is disposed on the fourth surface 12d so as to cover the fourth extended electrode portions 24d of the second inner electrodes 16b. The fourth outer electrode 230d is further disposed so as to cover a portion of the first surface 12a and a part of the second surface 12b. The fourth outer electrode 230d is electrically coupled to the fourth extended electrode portions 24d of the second inner electrodes 16b.

Furthermore, as illustrated in FIG. 22, the outer electrodes 230 disposed on the fifth surface 12e or the sixth surface 12f, to which no inner electrode 16 is extended, preferably have a U-shape, any one of the short sides of the side surface to which no inner electrode 16 is extended and the portions from respective ends of the short side to the middle of the respective long sides.

Within the multilayer body 12, the first opposing electrode portions 22a of the first inner electrodes 16a and the second opposing electrode portions 22b of the second inner electrodes 16b face each other with the inner dielectric layers 14a interposed therebetween to generate capacitance. This can provide capacitance between the first and second outer electrodes 230a and 230b, to which the first inner electrodes 16a are coupled, and between the third and fourth outer electrodes 230c and 230d, to which the second inner electrodes 16b are coupled. The capacitor characteristics are thus provided.

The first outer electrode 230a, the second outer electrode 230b, the third outer electrode 230c, and the fourth outer electrode 230d each include the underlying plating layer 32, thin-film layers 34, and surface plating layer 36.

Specifically, the first outer electrode 230a includes the first underlying plating layer 32a, first thin-film layers 34a, and first surface plating layer 36a. The second outer electrode 230b includes the second underlying plating layer 32b, second thin-film layers 34b, and second surface plating layer 36b. The third outer electrode 230c includes the third underlying plating layer 32c, third thin-film layers 34c, and third surface plating layer 36c. The fourth outer electrode 230d includes the fourth underlying plating layer 32d, fourth thin-film layers 34d, and fourth surface plating layer 36d.

### Underlying Plating Layer

The underlying plating layers 32 include the outer plating regions 40, which are arranged on the third surface 12c and the fourth surface 12d, the inner plating regions 42, which are arranged inside the third to sixth surfaces 12c to 12f and are extended toward the first surface 12a, and the inner plating regions 44, which are extended toward the second surface 12b. That is, the inner plating regions 42 are extended from the inner electrode 16 closest to the first surface 12a in the lamination direction x, toward the first surface 12a. The inner plating regions 44 are extended from the inner electrode 16 closest to the second surface 12b in the lamination direction x toward the second surface 12b. Hereinafter, the specific configuration of the underlying plating layers 32 will be described.

The first underlying plating layer 32a includes the first outer plating region 40a, the first inner plating region 42a, and a first inner plating region 44a.

The first outer plating region 40a is arranged on the surface of the third surface 12c of the multilayer body 12 so as to cover the first extended electrode portions 24a of the first inner electrodes 16a exposed in the third surface 12c of the multilayer body 12.

The first inner plating region 42a is arranged in a region of the first surface 12a located at a corner portion defined by the third and fifth surfaces 12c and 12e and is extended from the inner electrode 16 closest to the first surface 12a in the lamination direction x, toward the first surface 12a.

The first inner plating region 44a is arranged in a region of the second surface 12b located at a corner portion defined by the third and fifth surfaces 12c and 12e and is extended from the inner electrode 16 closest to the second surface 12b in the lamination direction x, toward the second surface 12b.

As illustrated in FIG. 24, the distance between the first surface 12a and the inner electrode 16 closest to the first surface 12a is longer than the dimension of the first inner plating region 42a in the lamination direction x. The first inner plating region 42a is therefore recessed from the first surface 12a.

When the distance between the first surface 12a and the inner electrode 16 closest to the first surface 12a is longer than the dimension of the first inner plating region 42a in the lamination direction x, the distance between the first inner plating region 42a and the first surface 12a in the lamination direction x is, for example, preferably less than or equal to about 0.5 μm. An exposed width of the first inner plating region 42a is, for example, preferably greater than or equal to about 0.02 μm and less than or equal to about 3.1 μm. This can improve the bonding strength between the corresponding first thin-film layer 34a and the multilayer body 12.

The distance between the second surface 12b and the inner electrode 16 closest to the second surface 12b is longer than the dimension of the first inner plating region 44a in the lamination direction x. The first inner plating region 44a is therefore recessed from the second surface 12b.

When the distance between the second surface 12b and the inner electrode 16 closest to the second surface 12b is longer than the dimension of the first inner plating region 44a in the lamination direction x, the distance between the first inner plating region 44a and the second surface 12b in the lamination direction x is, for example, preferably less than or equal to about 0.5 μm. An exposed width of the first inner plating region 44a is, for example, preferably greater than or equal to about 0.02 μm and less than or equal to about 3.1 μm.

This can improve the bonding strength between the corresponding first thin-film layer 34a and the multilayer body 12.

On the other hand, the first inner plating region 42a may, not illustrated, protrude from the first surface 12a. In such a configuration, since the distance between the first surface 12a and the inner electrode 16 closest to the first surface 12a is shorter than the dimension of the first inner plating region 42a in the lamination direction x, the first inner plating region 42a protrudes from the first surface 12a. When the distance between the first surface 12a and the inner electrode 16 closest to the first surface 12a is shorter than the dimension of the first inner plating region 42a in the lamination direction x, therefore, the first inner plating region 42a protrudes in the first surface 12a and covers the first surface 12a. This can improve the humidity resistance.

Similarly, the first inner plating region 44a may protrude from the second surface 12b. In such a configuration, since the distance between the second surface 12b and the inner electrode 16 closest to the second surface 12b is shorter than the dimension of the first inner plating region 44a in the lamination direction x, the first inner plating region 44a protrudes from the second surface 12b. When the distance between the second surface 12b and the inner electrode 16 closest to the second surface 12b is shorter than the dimension of the first inner plating region 44a in the lamination direction x, therefore, the first inner plating region 44a protrudes in the second surface 12b and covers the second surface 12b. This can improve the humidity resistance.

As described above, the surface of the multilayer body 12 includes an uneven surface due to the first inner plating regions 42a and 44a. An anchor effect to the uneven surface can further improve the adhesion between the first thin-film layers 34a and the multilayer body 12.

The surface roughness ratio of the first outer-layer portion 20a, which faces the first inner plating region 42a, is, for example, preferably greater than or equal to about 1.5. The surface roughness ratio of the second outer-layer portion 20b, which faces the first inner plating region 44a, is, for example, preferably greater than or equal to about 1.5. The surface roughness ratio indicates the ratio of the actual path length to the straight-line length.

The second underlying plating layer 32b includes the second outer plating region 40b, the second inner plating region 42b, and a second inner plating region 44b.

The second outer plating region 40b is arranged on the surface of the fourth surface 12d of the multilayer body 12 so as to cover the second extended electrode portions 24b of the first inner electrodes 16a exposed in the fourth surface 12d of the multilayer body 12.

The second inner plating region 42b is arranged in a region of the first surface 12a located at a corner portion defined by the fourth and sixth surfaces 12d and 12f and is extended from the inner electrode 16 closest to the first surface 12a in the lamination direction x, toward the first surface 12a.

The second inner plating region 44b is arranged in a region of the second surface 12b located at a corner portion defined by the fourth and sixth surfaces 12d and 12f and is extended from the inner electrode 16 closest to the second surface 12b in the lamination direction x, toward the second surface 12b.

Similarly to the first inner plating region 42a, the second inner plating region 42b may protrude from the first surface 12a or be recessed from the first surface 12a.

When the distance between the first surface 12a and the inner electrode 16 closest to the first surface 12a is shorter than the dimension of the second inner plating region 42b in the lamination direction x, the second inner plating region 42b protrudes from the first surface 12a. On the other hand, when the distance between the first surface 12a and the inner electrode 16 closest to the first surface 12a is longer than the dimension of the second inner plating region 42b in the lamination direction x, the second inner plating region 42b is recessed from the first surface 12a. When the multilayer body 12 includes an uneven surface due to the second inner plating region 42b, its anchor effect can further improve the adhesion between the corresponding second thin-film layer 34b and the multilayer body 12.

Similarly to the first inner plating region 44a, the second inner plating region 44b may protrude from the second surface 12b or be recessed from the second surface 12b.

When the distance between the second surface 12b and the inner electrode 16 closest to the second surface 12b is shorter than the dimension of the second inner plating region 44b in the lamination direction x, the second inner plating region 44b protrudes from the second surface 12b. On the other hand, when the distance between the second surface 12b and the inner electrode 16 closest to the second surface 12b is longer than the dimension of the second inner plating region 44b in the lamination direction x, the second inner plating region 44b is recessed from the second surface 12b. When the multilayer body 12 includes an uneven surface due to the second inner plating region 44b, its anchor effect can further improve the adhesion between the corresponding second thin-film layer 34b and the multilayer body 12.

The other configurations of the second inner plating region 42b are the same or substantially the same as those of the first inner plating region 42a. Furthermore, the configurations of the second inner plating region 44b are the same or substantially the same as those of the first inner plating region 44a.

The third underlying plating layer 32c includes the third outer plating region 40c, the third inner plating region 42c, and a third inner plating region 44c.

The third outer plating region 40c is arranged on the surface of the third surface 12c of the multilayer body 12 so as to cover the third extended electrode portions 24c of the second inner electrodes 16b exposed in the third surface 12c of the multilayer body 12.

The third inner plating region 42c is arranged in a region of the first surface 12a located at a corner portion defined by the third and sixth surfaces 12c and 12f and is extended from the inner electrode 16 closest to the first surface 12a in the lamination direction x, toward the first surface 12a.

The third inner plating region 44c is arranged in a region of the second surface 12b located at a corner portion defined by the third and sixth surfaces 12c and 12f and is extended from the inner electrode 16 closest to the second surface 12b in the lamination direction x, toward the second surface 12b.

Similarly to the first inner plating region 42a, the third inner plating region 42c may protrude from the first surface 12a or be recessed from the first surface 12a.

When the distance between the first surface 12a and the inner electrode 16 closest to the first surface 12a is shorter than the dimension of the third inner plating region 42c in the lamination direction x, the third inner plating region 42c protrudes from the first surface 12a. On the other hand, when the distance between the first surface 12a and the inner electrode 16 closest to the first surface 12a is longer than the dimension of the third inner plating region 42c in the lamination direction x, the third inner plating region 42c is recessed from the first surface 12a. When the multilayer body 12 includes an uneven surface due to the third inner plating region 42c, its anchor effect can further improve the adhesion between the corresponding third thin-film layer 34c and the multilayer body 12.

Similarly to the first inner plating region 44a, the third inner plating region 44c may protrude from the second surface 12b or be recessed from the second surface 12b.

When the distance between the second surface 12b and the inner electrode 16 closest to the second surface 12b is shorter than the dimension of the third inner plating region 44c in the lamination direction x, the third inner plating region 44c protrudes from the second surface 12b. On the other hand, when the distance between the second surface 12b and the inner electrode 16 closest to the second surface 12b is longer than the dimension of the third inner plating region 44c in the lamination direction x, the third inner plating region 44c is recessed from the second surface 12b. When the surface of the multilayer body 12 includes an uneven surface due to the third inner plating region 44c, its anchor effect can further improve the adhesion between the corresponding third thin-film layer 34c and the multilayer body 12.

The other configurations of the third inner plating region 42c are the same or substantially the same as those of the first inner plating region 42a. Furthermore, the configurations of the third inner plating region 44c are the same or substantially the same as those of the first inner plating region 44a.

The fourth underlying plating layer 32d includes the fourth outer plating region 40d, the fourth inner plating region 42d, and a fourth inner plating region 44d.

The fourth outer plating region 40d is arranged on the surface of the fourth surface 12d of the multilayer body 12 so as to cover the fourth extended electrode portions 24d of the second inner electrodes 16b exposed in the fourth surface 12d of the multilayer body 12.

The fourth inner plating region 42d is arranged in a region of the first surface 12a located at a corner portion defined by the fourth and fifth surfaces 12d and 12e and is extended from the inner electrode 16 closest to the first surface 12a in the lamination direction x, toward the first surface 12a.

The fourth inner plating region 44d is arranged in a region of the second surface 12b located at a corner portion defined by the fourth and fifth surfaces 12d and 12e and is extended from the inner electrode 16 closest to the second surface 12b in the lamination direction x, toward the second surface 12b.

Similarly to the first inner plating region 42a, the fourth inner plating region 42d may protrude from the first surface 12a or be recessed from the first surface 12a.

When the distance between the first surface 12a and the inner electrode 16 closest to the first surface 12a is shorter than the dimension of the fourth inner plating region 42d in the lamination direction x, the fourth inner plating region 42d protrudes from the first surface 12a. On the other hand, when the distance between the first surface 12a and the inner electrode 16 closest to the first surface 12a is longer than the dimension of the fourth inner plating region 42d in the lamination direction x, the fourth inner plating region 42d is recessed from the first surface 12a. When the multilayer body 12 includes an uneven surface due to the fourth inner plating region 42d, its anchor effect can further improve the adhesion between the corresponding fourth thin-film layer 34d and the multilayer body 12.

Similarly to the first inner plating region 44a, the fourth inner plating region 44d may protrude from the second surface 12b or be recessed from the second surface 12b.

When the distance between the second surface 12b and the inner electrode 16 closest to the second surface 12b is shorter than the dimension of the fourth inner plating region 44d in the lamination direction x, the fourth inner plating region 44d protrudes from the second surface 12b. On the other hand, when the distance between the second surface 12b and the inner electrode 16 closest to the second surface 12b is longer than the dimension of the fourth inner plating region 44d in the lamination direction x, the fourth inner plating region 44d is recessed from the second surface 12b. When the multilayer body 12 includes an uneven surface due to the fourth inner plating region 44d, its anchor effect can further improve the adhesion between the corresponding fourth thin-film layer 34d and the multilayer body 12.

The other configurations of the fourth inner plating region 44d are the same or substantially the same as those of the first inner plating region 44a.

The outer plating regions 40 and the inner plating regions 42 and 44 are preferably made of the same type of metal component. The outer plating regions 40 and the inner plating regions 42 and 44, which define the underlying plating layers 32, for example, preferably include Cu plating although it depends on the connectivity with the inner electrodes 16.

The upper end of the first underlying plating layer 32a of the first outer electrode 230a may overlap the underside of the corresponding first thin-film layer 34a on the edge portion defined by the first and third surfaces 12a and 12c of the multilayer body 12 and the edge portion defined by the first and fifth surfaces 12a and 12e of the multilayer body 12 or to be spaced apart from the first thin-film layer 34a. In such a configuration, the first outer plating region 40a may cover the edge portion defined by the third and fifth surfaces 12c and 12e.

The upper end of the second underlying plating layer 32b of the second outer electrode 230b may overlap the underside of the corresponding second thin-film layer 34b on the edge portion defined by the first and fourth surfaces 12a and 12d of the multilayer body 12 and the edge portion defined by the first and sixth surfaces 12a and 12f of the multilayer body 12 or to be spaced apart from the second thin-film layer 34b. In such a configuration, the second outer plating region 40b may cover the edge portion defined by the fourth and sixth surfaces 12d and 12f.

The upper end of the third underlying plating layer 32c of the third outer electrode 230c may overlap the underside of the corresponding third thin-film layer 34c on the edge portion defined by the first and third surfaces 12a and 12c of the multilayer body 12 and the edge portion defined by the first and sixth surfaces 12a and 12f of the multilayer body 12 or to be spaced apart from the third thin-film layer 34c. In such a configuration, the third outer plating region 40c may cover the edge portion defined by the third and sixth surfaces 12c and 12f.

The upper end of the fourth underlying plating layer 32d of the fourth outer electrode 230d may overlap the underside of the corresponding fourth thin-film layer 34d on the edge portion defined by the first and fourth surfaces 12a and 12d of the multilayer body 12 and the edge portion defined by the first and fifth surfaces 12a and 12e of the multilayer body 12 or to be spaced apart from the fourth thin-film layer 34d. In such a configuration, the fourth outer plating region 40d may cover the edge portion defined by the fourth and fifth surfaces 12d and 12e.

### Thin-Film Layer

The thin-film layers 34 cover the inner plating regions 42 and 44 of the underlying plating layers 32. The thin-film layers 34 include the first thin-film layers 34a, the second thin-film layers 34b, the third thin-film layers 34c, and the fourth thin-film layers 34d.

The first thin-film layers 34a cover a portion of the first surface 12a and the second surface 12b of the multilayer body 12 on the third surface 12c side and the fifth surface 12e side and the first inner plating regions 42a and 44a of the first underlying plating layer 32a. The first thin-film layers 34a may be spaced apart from the first outer plating region 40a or may overlap the first outer plating region 40a. The first thin-film layers 34a may be shaped so as to define a recess in the surface of the first surface plating layer 36a.

The second thin-film layers 34b cover a portion of the first surface 12a and the second surface 12b of the multilayer body 12 on the fourth surface 12d side and the sixth surface 12f side and the second inner plating regions 42b and 44b of the second underlying plating layer 32b. The second thin-film layers 34b may be spaced apart from the second outer plating region 40b or may overlap the second outer plating region 40b. The second thin-film layers 34b may be shaped so as to define a recess in the surface of the second surface plating layer 36b.

The third thin-film layers 34c cover a portion of the first surface 12a and the second surface 12b of the multilayer body 12 on the third surface 12c side and the sixth surface 12f side and the third inner plating regions 42c and 44c of the third underlying plating layer 32c. The third thin-film layers 34c may be spaced apart from the third outer plating region 40c or may overlap the third outer plating region 40c. The third thin-film layers 34c may be shaped so as to define a recess in the surface of the later-described third surface plating layer 36c.

The fourth thin-film layers 34d cover a portion of the first surface 12a and the second surface 12b of the multilayer body 12 on the fourth surface 12d side and the fifth surface 12e side and the fourth inner plating regions 42d and 44d of the fourth underlying plating layer 32d. The fourth thin-film layers 34d may be spaced apart from the fourth outer plating region 40d or may overlap the fourth outer plating region 40d. The fourth thin-film layers 34d may be shaped so as to define a recess in the surface of the later-described fourth surface plating layer 36d.

Each of the first to fourth thin-film layers 34a to 34d is preferably a metal particle deposition formed by sputtering, vapor deposition, or the like, for example. The thickness of the first to fourth thin-film layers 34a to 34d in the direction connecting the first and second surfaces 12a and 12b of the multilayer body 12 can thus be less than or equal to about 1 μm, for example. Thus, the dimension of the multilayer ceramic capacitor 210 in the lamination direction x can be sufficiently reduced, and the multilayer ceramic capacitor 10 can be made thinner.

### Surface Plating Layer

The surface plating layers 36 include the first surface plating layer 36a, the second surface plating layer 36b, the third surface plating layer 36c, and the fourth surface plating layer 36d.

The first surface plating layer 36a covers the first thin-film layers 34a and the first outer plating region 40a of the first underlying plating layer 32a disposed on the third surface 12c of the multilayer body 12.

The second surface plating layer 36b covers the second thin-film layers 34b and the second outer plating region 40b of the second underlying plating layer 32b disposed on the fourth surface 12d of the multilayer body 12.

The third surface plating layer 36c covers the third thin-film layers 34c and the third outer plating region 40c of the third underlying plating layer 32c disposed on the third surface 12c of the multilayer body 12.

The fourth surface plating layer 36d covers the fourth thin-film layers 34d and the fourth outer plating region 40d of the fourth underlying plating layer 32d disposed on the fourth surface 12d of the multilayer body 12.

The surface plating layers 36 preferably include at least one of Cu, Ni, Sn, Pb, Au, Ag, Pd, Bi, Zn, or the like or an alloy including the metal, for example. Preferably, the plating layers do not include glass.

The surface plating layers 36 may each include only Sn plating, for example, or may have a two-layer structure including Ni plating and Sn plating or a two-layer structure of Ni plating and Cu plating.

The multilayer ceramic capacitor 210 according to the third example embodiment illustrated in FIG. 22 provides the same or substantially the same advantageous effects as the multilayer ceramic capacitor 10.

### 2. Method for Manufacturing Multilayer Ceramic Capacitor

Hereinafter, an example of a method for manufacturing the multilayer ceramic capacitor according to the third example embodiment will be described.

First, dielectric sheets, conducting paste for inner electrodes, and conducting paste for peripheral electrodes are prepared. The dielectric sheets, conducting paste for inner electrodes, and conducting paste for peripheral electrodes include a binder and a solvent. The binder and solvent can be known materials.

Next, on the dielectric sheets, predetermined patterns are printed with the conducting paste for inner electrodes and the conducting paste for peripheral electrodes by, for example, ink-jet printing, screen printing, gravure printing, or the like. Thus, the dielectric sheets with the patterns for the first inner electrodes and first peripheral electrodes formed thereon and the dielectric sheets with the patterns for the second inner electrodes and second peripheral electrodes formed thereon are prepared. Then, the dielectric sheets with the patterns for the first inner electrodes and first peripheral electrodes formed thereon and the dielectric sheets with the patterns for the second inner electrodes and second peripheral electrodes formed thereon are laminated to form a portion that will serve as the inner-layer portion 18.

For printing patterns with each conducting paste, first, the pattern with the conducting paste for inner electrodes is printed, and then the pattern with the conducting paste for peripheral electrodes is printed.

Next, a predetermined number of dielectric sheets with no inner electrode pattern and no peripheral electrode pattern printed thereon are laminated to form a portion that will define and function as the first outer-layer portion 20a on the first surface 12a side. Then, the portion prepared above to define and function as the inner-layer portion 18 is laminated thereon. On the portion that will define and function as the inner-layer portion 18, a predetermined number of dielectric sheets with no inner electrode pattern and no peripheral electrode pattern printed thereon are laminated to form a portion that will define and function as the second outer-layer portion 20b on the second surface 12b side. The multilayer sheet is thus prepared.

Next, the multilayer sheet is pressed in the lamination direction by, for example, an isostatic press to prepare a multilayer block.

Subsequently, the multilayer block is cut to a predetermined size, and a multilayer chip is thus separated. In this process, the multilayer chip may undergo, for example, barrel polishing to have corner and edge portions rounded.

Next, the multilayer chip is sintered, thus preparing the multilayer body 12. The sintering temperature, which depends on the materials of the ceramic and inner electrodes, is, for example, preferably higher than or equal to about 900° C. and lower than or equal to about 1400° C.

In this process, the first extended electrode portions 24a of the first inner electrodes 16a and the third extended electrode portions 24c of the second inner electrodes 16b are exposed in the third surface 12c of the multilayer body 12. The second extended electrode portions 24b of the first inner electrodes 16a and the fourth extended electrode portions 24d of the second inner electrodes 16b are exposed in the fourth surface 12d of the multilayer body 12.

Then, the outer electrodes 230 are formed on the multilayer body 12.

First, holes for forming the inner plating regions 42 of the underlying plating layers 32 are formed. The method for forming these holes is not limited. The formation of the holes may be performed before sintering of the multilayer chip.

Next, the underlying plating layers 32 are formed on the surface of the multilayer body 12.

The first outer plating region 40a of the first underlying plating layer 32a is formed on the third surface 12c of the multilayer body 12, and the first inner plating region 42a of the first underlying plating layer 32a is formed in the first surface 12a. The first inner plating region 44a of the first underlying plating layer 32a is formed in the second surface 12b.

The second outer plating region 40b of the second underlying plating layer 32b is formed on the fourth surface 12d of the multilayer body 12, and the second inner plating region 42b of the second underlying plating layer 32b is formed in the first surface 12a. The second inner plating region 44b of the second underlying plating layer 32b is formed in the second surface 12b.

The third outer plating region 40c of the third underlying plating layer 32c is formed on the third surface 12c of the multilayer body 12, and the third inner plating region 42c of the third underlying plating layer 32c is formed in the first surface 12a. The third inner plating region 44c of the third underlying plating layer 32c is formed in the second surface 12b.

The fourth outer plating region 40d of the fourth underlying plating layer 32d is formed on the fourth surface 12d of the multilayer body 12, and the fourth inner plating region 42d of the fourth underlying plating layer 32d is formed in the first surface 12a. The fourth inner plating region 44d of the fourth underlying plating layer 32d is formed in the second surface 12b.

The underlying plating layers 32 are, for example, Cu plating herein and are formed by electrolytic plating or electroless plating. After plating, heat treatment is performed on the multilayer body 12 to evaporate residual water remaining in the plating film or in the interface between the multilayer body 12 and the underlying plating layers 32.

Next, the multilayer body 12 with the underlying plating layers 32 formed thereon is placed on a work table, and the thin-film layers 34 are formed on the first and second surfaces 12a and 12b by sputtering.

Thereafter, the surface plating layers 36 are formed on the thin-film layers 34 and the surface of the multilayer body 12. To be more specific, for example, as the surface plating layers 36, Ni plating layers and Sn plating layers are formed on the thin-film layers 34. The plating process can use either electrolytic plating or electroless plating. However, electroless plating needs pretreatment using a catalyst or the like to increase the plating deposition rate, and its process is complicated. Therefore, it is generally preferable to use electrolytic plating.

The multilayer ceramic capacitor 210 according to the third example embodiment illustrated in FIG. 22 can be manufactured as described above.

### D. Experimental Examples

Next, in order to confirm the advantageous effects of the multilayer ceramic capacitors according to example embodiments of the present invention described above, samples of multilayer ceramic capacitors were prepared according to the above-described manufacturing method as experimental samples and were subjected to humidity resistance tests for evaluating the humidity resistance of each sample. In the samples of the multilayer ceramic capacitors, for a given inner plating region, the distance between the inner plating region and the first surface in the lamination direction was varied.

### (1) Specification of Multilayer Ceramic Capacitor Prepared as Sample of Experimental Example

Multilayer ceramic capacitors included in multilayer ceramic electronic components were prepared as samples using the manufacturing method according to the example embodiments.
Dimensions (designed values) of multilayer ceramic capacitor: L×W×T=about 600 μm×about 600 μm×about 80 μm
Ceramic Material: BaTiO₃
Inner electrode material: Ni
Outer electrode
Underlying plating layer: Cu
Thin-film layer: Sputtered film including at least one of Ni, Cr, and Cu
Surface plating layer: Two-layer structure of Ni plating layer and Sn plating layer

### (2) Method of Humidity Resistance Test

Humidity stress tests were performed on the samples as follows. Each sample was mounted on a mounting board using solder. Then, the samples were subjected to the humidity resistance tests in a high-temperature and high-humidity chamber set to about 85° C. and a relative humidity of about 85% RH at voltage of about 4 V for about 144 hours. Samples whose insulation resistance value (IR value) decreased by one order of magnitude or more were determined as defective (NG) with degraded humidity resistance. The number of samples for each distance was set to 100.

### (3) Results

The evaluation results are shown in Tables 1 to 4.

Table 1 shows the evaluation results when the exposed width d of the inner plating regions was set to about 0.02 μm and the distance t between the inner plating regions and the first surface in the lamination direction was varied from about 0.1 μm to about 1.5 μm.

Table 2 shows the evaluation results when the exposed width d of the inner plating regions was set to about 1.7 μm and the distance t between the inner plating regions and the first surface in the lamination direction was varied from about 0.1 μm to about 1.5 μm.

Table 3 shows the evaluation results when the exposed width d of the inner plating regions was set to about 3.1 μm and the distance t between the inner plating regions and the first surface in the lamination direction was varied from about 0.1 μm to about 1.5 μm.

Table 4 shows the evaluation results when the exposed width d of the inner plating regions was set to about 3.6 μm and the distance t between the inner plating regions and the first surface in the lamination direction was varied from about 0.1 μm to about 1.5 μm.

TABLE 1

| Sample No. | 1 | 2 | 3 | 4 | 5 | 6 |
|---|---|---|---|---|---|---|
| Exposed Width d of inner | 0.02 | | | | | |
| plating region (μm) | | | | | | |
| Distance t between inner | 0.1 | 0.4 | 0.5 | 0.6 | 1.0 | 1.5 |
| plating region and first | | | | | | |
| surface in lamination | | | | | | |
| direction (μm) | | | | | | |
| Number of samples degraded | 0/100 | 0/100 | 0/100 | 0/100 | 0/100 | 1/100 |
| in humidity resistance test | | | | | | |

TABLE 2

| Sample No. | 7 | 8 | 9 | 10 | 11 | 12 |
|---|---|---|---|---|---|---|
| Exposed Width d of inner | 1.7 | | | | | |
| plating region (μm) | | | | | | |
| Distance t between inner | 0.1 | 0.4 | 0.5 | 0.6 | 1.0 | 1.5 |
| plating region and first | | | | | | |
| surface in lamination | | | | | | |
| direction (μm) | | | | | | |
| Number of samples degraded | 0/100 | 0/100 | 0/100 | 1/100 | 2/100 | 4/100 |
| in humidity resistance test | | | | | | |

TABLE 3

| Sample No. | 13 | 14 | 15 | 16 | 17 | 18 |
|---|---|---|---|---|---|---|
| Exposed Width d of inner | 3.1 | | | | | |
| plating region (μm) | | | | | | |
| Distance t between inner | 0.1 | 0.4 | 0.5 | 0.6 | 1.0 | 1.5 |
| plating region and first | | | | | | |
| surface in lamination | | | | | | |
| direction (μm) | | | | | | |
| Number of samples degraded | 0/100 | 0/100 | 0/100 | 2/100 | 3/100 | 5/100 |
| in humidity resistance test | | | | | | |

TABLE 4

| Sample No. | 19 | 20 | 21 | 22 | 23 | 24 |
|---|---|---|---|---|---|---|
| Exposed Width d of inner | 3.6 | | | | | |
| plating region (μm) | | | | | | |
| Distance t between inner | 0.1 | 0.4 | 0.5 | 0.6 | 1.0 | 1.5 |
| plating region and first | | | | | | |
| surface in lamination | | | | | | |
| direction (μm) | | | | | | |
| Number of samples degraded | 0/100 | 0/100 | 1/100 | 2/100 | 3/100 | 6/100 |
| in humidity resistance test | | | | | | |

According to Tables 1 to 4, when the exposed width d of the inner plating regions was varied from about 0.02 to about 3.6 μm and the distance t between the inner plating regions and the first surface in the lamination direction was varied from about 0.1 to about 1.5 μm, the number of samples determined to have degraded humidity resistance was less than or equal to six for any distance t. This showed that the number of degraded samples was relatively low.

According to Tables 1 to 3, when the exposed width d of the inner plating regions was varied from about 0.02 to about 3.1 μm and the distance t between the inner plating regions and the first surface in the lamination direction was varied from about 0.1 to about 1.5 μm, the number of samples determined to have degraded humidity resistance was less than or equal to five for any distance t. This showed that the results were better.

According to Tables 1 to 4, when the exposed width d of the inner plating regions was varied from about 0.02 to about 3.6 μm and the distance t between the inner plating regions and the first surface in the lamination direction was varied from about 0.1 to about 1.5 μm, the number of samples determined to have degraded humidity resistance was less than or equal to one for a distance t of less than or equal to about 0.5 μm. This showed that the number of samples determined to have degraded humidity resistance could be further reduced.

The above-described results show that the humidity resistance reliability of the multilayer ceramic capacitors can be improved by providing, as the underlying plating layers, the inner plating regions extended from the inner electrode located on the first surface side toward the first surface and covering, with the thin-film layers, the inner plating regions within the third to sixth surfaces.

Thus, the example embodiments of the present invention are disclosed by the above description, but the present invention is not limited to this.

That is, various changes can be made to the example embodiments described above in terms of the mechanisms, shapes, materials, quantities, positions, arrangements, and the like without departing from the scope of the present invention. Such changes are included in the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor, comprising:
a multilayer body including a first surface and a second surface facing each other in a lamination direction, a third surface and a fourth surface facing each other in a first direction perpendicular or substantially perpendicular to the lamination direction, and a fifth surface and a sixth surface facing each other in a second direction perpendicular or substantially perpendicular to the lamination direction and the first direction;
a first outer electrode on the first surface and the third surface;
a second outer electrode on the first surface and the fourth surface;
a third outer electrode on the first surface and the third surface; and
a fourth outer electrode on the first surface and the fourth surface; wherein
the first outer electrode includes a first underlying plating layer, a first thin-film layer, and a first surface plating layer;
the first underlying plating layer includes:
a first outer plating region on the third surface and coupled to a first inner electrode; and
a first inner plating region extended toward the first surface and coupled to the first inner electrode;
the first inner plating region is located inside the third to sixth surfaces; and
the first thin-film layer covers the first inner plating region.

2. The multilayer ceramic capacitor according to claim 1, wherein the multilayer body includes:
an outer-layer portion between the first surface and an inner electrode closest to the first surface; and
a thickness of the outer-layer portion in the lamination direction is greater than or equal to about 1.0 μm and less than or equal to about 4.0 μm.

3. The multilayer ceramic capacitor according to claim 1, wherein a thickness of the first inner plating region in the lamination direction is different from a thickness between the first surface and an inner electrode closest to the first surface in the lamination direction.

4. The multilayer ceramic capacitor according to claim 3, wherein the thickness of the first inner plating region in the lamination direction is greater than the thickness between the first surface and the inner electrode closest to the first surface, and the first inner plating region covers the first surface.

5. The multilayer ceramic capacitor according to claim 3, wherein
the thickness of the first inner plating region in the lamination direction is smaller than the thickness between the first surface and the inner electrode closest to the first surface; and
a distance from the first surface to the first inner plating region in the lamination direction is less than or equal to about 0.5 μm.

6. The multilayer ceramic capacitor according to claim 5, wherein an exposed width of the first inner plating region is greater than or equal to about 0.02 μm and less than or equal to about 3.1 μm.

7. The multilayer ceramic capacitor according to claim 1, wherein
the multilayer body includes an outer-layer portion between the first surface and an inner electrode closest to the first surface; and
a surface roughness ratio of a contact area between the first inner plating region and the outer-layer portion is greater than or equal to about 1.5.

8. The multilayer ceramic capacitor according to claim 7, wherein a thickness of the outer-layer in the lamination direction is greater than or equal to about 1.0 μm and less than or equal to about 4.0 μm.

9. The multilayer ceramic capacitor according to claim 1, wherein a dimension L of the multilayer body in the first direction and a dimension W of the multilayer body in the second direction satisfies about 0.85≤L/W≤about 1.00.

10. The multilayer ceramic capacitor according to claim 1, wherein the first inner plating region is recessed from the first surface.

11. The multilayer ceramic capacitor according to claim 1, wherein the first inner plating region protrudes from the first surface.

12. The multilayer ceramic capacitor according to claim 1, wherein the first outer plating region and the first inner plating region include a same metal component.

13. The multilayer ceramic capacitor according to claim 1, wherein
the first outer electrode is on the first surface, the third surface and the fifth surface;
the second outer electrode is on the first surface, the fourth surface and the sixth surface;
the third outer electrode on the first surface, the third surface and the sixth surface; and
the fourth outer electrode on the first surface, the fourth surface and the fifth surface.

14. The multilayer ceramic capacitor according to claim 13, wherein an area of the first outer electrode on the third surface is greater than an area of the first outer electrode on the fifth surface.

15. The multilayer ceramic capacitor according to claim 13, wherein a shape of the first outer electrode on the fifth surface is a U-shape.

16. The multilayer ceramic capacitor according to claim 1, wherein the first thin-film layer is a sputtered electrode.

17. The multilayer ceramic capacitor according to claim 1, wherein the first thin-film layer includes a dielectric material and a metal component.
